(19) United States
(12) Patent Application Publication
(10) Pub. No.: US 2025/0247589 A1
(43) Pub. Date: Jul. 31, 2025

(54) METHOD AND APPARATUS FOR DESCRIBING SUBSAMPLES IN A MEDIA FILE

(71) Applicant: CANON KABUSHIKI KAISHA, Tokyo (JP)

(72) Inventors: Romain BELLESSORT, ST GREGOIRE (FR); Lionel TOCZE, SAINT DOMINEUC (FR); Franck DENOUAL, SAINT DOMINEUC (FR); Frédéric MAZE, LANGAN (FR); Hervé RUELLAN, RENNES (FR); Jean LE FEUVRE, CACHAN (FR)

(21) Appl. No.: 18/854,402

(22) PCT Filed: Mar. 29, 2023
(86) PCT No.: PCT/EP2023/058166

§ 371 Date: Oct. 4, 2024

(30) Foreign Application Priority Data
Apr. 5, 2022 (GB) 2205003.3
Jul. 11, 2022 (GB) 2210192.7
Oct. 17, 2022 (GB) 2215332.4

(51) Int. Cl. H04N 21/84

(52) U.S. Cl. CPC H04N 21/84

(57) ABSTRACT

The present invention concerns a method of encapsulating media data in a media file, the media data comprising one or more samples, at least some of the one or more samples being organized into subsamples, the method comprising: generating a reference table descriptive metadata describing a table of subsample's properties; generating subsample descriptive metadata describing the subsample organization, the subsample descriptive metadata comprising for each subsample a subsample description, the subsample description comprising properties; wherein at least one subsample description comprises a reference to a set of at least one property value in the reference table descriptive metadata.

### FIELD OF THE INVENTION

The present disclosure concerns a method and a device for encapsulating media data into a media file. It concerns more particularly the encapsulation of samples of media data where samples of media data are organized into subsamples.

### BACKGROUND OF THE INVENTION

The ISO base media file format (ISOBMFF, also called file format) is a general file format specified for the encapsulation of media data into a media file. This file format is generic, and it has been used as the basis for a number of other more specific file formats (e.g., ISO/IEC 14496-15 for the carriage of NAL unit structured video, ISO/IEC 23008-12 for the Image File Format or High Efficiency Image File Format (HEIF), ISO/IEC 23090-2 for the Omnidirectional MediA Format (OMAF), ISO/IEC 23090-10 for the carriage of Visual Volumetric Video-based Coding or ISO/IEC 23090-18 for the carriage of G-PCC Data . . . ). All these file formats use the generic structures and mechanisms defined in ISOBMFF possibly enriched with additional structures or mechanisms specific to a given type of media data.

ISOBMFF is standardized by the International Standardization Organization as ISO/IEC 14496-12. A media file comprises two different parts. A first part corresponds to the actual media data, while a second part corresponds to a description of the media data and is called the metadata part. Media data can be timed sequences of media data or untimed media data. For timed sequences of media data, such as audio-visual presentations, this metadata part contains characteristics of the timed sequences of media data like the timing, size, or media descriptive or transformative information. For untimed media data, this metadata part contains characteristics of the media data like size or media descriptive or transformative information.

An ISO base media file (that we later call media file or movie file or media presentation) may come as one file comprising the whole media presentation or as multiple segment files, each segment comprising a temporal portion of the media presentation. An ISO base media file is structured into “boxes”. In the file format, the overall presentation is called a movie. It is logically divided into tracks; each track represents a timed sequence of media (frames of video, audio samples, subtitles, for example). Within each track, each timed unit is called a sample. The sample is defined as all the media data associated with a same presentation time for a track. Each track comprises one or more sample descriptions; each sample in the track is associated with a sample description by reference. All the structure-data or metadata, including that defining the placement and timing of the media, is contained in structured boxes. The media data (frames of video, for example) is referred to by this structure-data or metadata. The overall duration of each track is defined in the metadata. Each sample has a defined duration. The exact decoding timestamp of a sample is defined by summing the duration of the preceding samples. And the exact presentation timestamp of a sample is defined by adding an offset (0 per default) to its decoding timestamp.

An ISOBMFF file may also comprise general untimed metadata, describing still images or sequence of untimed images through items.

A metadata structure (called subsample information box or ‘subs’) may be used in the metadata part of the media file to describe subsample (or sub-sample) organization (or subsample information) and content of subsamples (or sub-samples) inside samples of a track or of an item (as an associated item property). This subsample information box comprises a description of the subsample organization of each sample or item containing sub-samples. Each subsample is described by a set of properties. There may be cases where properties describing the subsample organization of a sample or item are identical for all or at least several subsamples. This invention focuses on the optimization of this subsample information box structure allowing reducing the description cost and avoiding the duplication of information.

### SUMMARY OF THE INVENTION

The present invention has been devised to address one or more of the foregoing concerns.

According to a first aspect of the invention there is provided a method of encapsulating media data in a media file, the media data comprising one or more samples, at least some of the one or more samples being organized into subsamples, the method comprising:
generating a reference table descriptive metadata describing a table of subsample's properties;
generating subsample descriptive metadata describing the subsample organization, the subsample descriptive metadata comprising for each subsample a subsample description, the subsample description comprising properties;
wherein at least one subsample description comprises a reference to a set of at least one property value in the reference table descriptive metadata.

In an embodiment:
the reference table descriptive metadata is a box further describing a group of entities;
subsample descriptive metadata is generated for each entity, the generated subsample descriptive metadata comprising a reference to the table of subsample's properties described in the box.

In an embodiment:
a plurality of reference table descriptive metadata are generated;
the reference is a reference in one of the reference table descriptive metadata;
the reference table descriptive metadata referred to by the reference is identified by its location in the metadata.

In an embodiment:
a plurality of reference table descriptive metadata are generated;
the reference is a reference in one of the reference table descriptive metadata;
the reference table descriptive metadata referred to by the reference is identified by a flags value of the reference table descriptive metadata.

In an embodiment:
a plurality of reference table descriptive metadata are generated;
the reference is a reference in one of the reference table descriptive metadata;
the reference table descriptive metadata referred to by the reference is identified by a table identifier comprised in each reference table descriptive metadata.

In an embodiment:
a plurality of reference table descriptive metadata are generated;
the reference is a reference in one of the reference table descriptive metadata;
the reference table descriptive metadata referred to by the reference is identified by a flag in each reference to the table descriptive metadata.

In an embodiment, the subsample descriptive metadata comprises an indication of the number of bits used for representing the reference.

In an embodiment, the subsample description comprises an arbitrary number of codec_specific_parameters values.

According to another aspect of the invention there is provided a method of reading media data in a media file, the media data comprising one or more samples, at least some of the one or more samples being organized into subsamples, the method comprising:
obtaining from the media file a reference table descriptive metadata describing a table of subsample's properties;
obtaining from the media file subsample descriptive metadata describing the subsample organization, the subsample descriptive metadata comprising for each subsample a subsample description, the subsample description comprising properties;
wherein at least one subsample description comprises a reference to a set of at least one property value in the reference table descriptive metadata; and
obtaining the properties describing the subsample from the subsample description and the set of at least one property value.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

According to another aspect of the invention there is provided a computer program which upon execution causes the method of the invention to be performed.

According to another aspect of the invention there is provided a device for encapsulating media data in a media file, the media data comprising one or more samples, at least some of the one or more samples being organized into subsamples, the device comprising a processor configured for:
generating a reference table descriptive metadata describing a table of subsample's properties;
generating subsample descriptive metadata describing the subsample organization, the subsample descriptive metadata comprising for each subsample a subsample description, the subsample description comprising properties;
wherein at least one subsample description comprises a reference to a set of at least one property value in the reference table descriptive metadata.

According to another aspect of the invention there is provided a device for reading media data in a media file, the media data comprising one or more samples, at least some of the one or more samples being organized into subsamples, the device comprising a processor configured for:
obtaining from the media file a reference table descriptive metadata describing a table of subsample's properties;
obtaining from the media file subsample descriptive metadata describing the subsample organization, the subsample descriptive metadata comprising for each subsample a subsample description, the subsample description comprising properties;
wherein at least one subsample description comprises a reference to a set of at least one property value in the reference table descriptive metadata; and
obtaining the properties describing the subsample from the subsample description and the set of at least one property value.

At least parts of the methods according to the invention may be computer implemented. Accordingly, the present invention may take the form of an entire hardware embodiment, an entire software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer-readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1a illustrates an example of samples organized in subsamples in a media file;

FIG. 1b illustrates an example of encapsulated media data organized as a non-fragmented presentation in a media file according to the ISO Base Media File Format;

FIG. 2 describes the content of the subsample information box ‘subs’ from the prior art;

FIG. 3 is an example of a system for the encapsulation or storage of multimedia presentations, where the proposed method for describing subsamples may be used;

FIG. 4 illustrates the encapsulation process according to one embodiment of the invention;

FIG. 5 illustrates the encapsulation process according to a second embodiment of the invention;

FIG. 6 illustrates a parsing method according to an embodiment of the invention;

FIG. 7 describes a first syntax embodiment of a subsample information box to support reference to a previous subsample and its common properties;

FIGS. 8a and 8b illustrates a first syntax embodiment of a subsample information box to support reference to an explicit pattern description and its common properties;

FIG. 9 is a schematic block diagram of a computing device for implementation of one or more embodiments of the invention;

FIG. 10 is another example of metadata structures providing subsample description;

FIG. 11 illustrates the main steps of a method for encapsulating subsample description using the data structure illustrated by FIG. 10;

FIG. 12 illustrates an example of syntax of a box describing a reference table according to embodiments of the invention;

FIG. 13 illustrates an example of SubSampleInformationBox according to embodiments of the invention;

FIG. 14 illustrates an example of syntax for describing a subsample according to embodiments of the invention;

FIG. 15 illustrates another example of syntax for describing a subsample according to embodiments of the invention;

FIG. 16 illustrates the main steps of a method for writing the reference table and the subsamples description in an embodiment of the invention;

FIG. 17 illustrates the main steps of a method for reading the reference table and the subsample description in an embodiment of the invention;

FIG. 18 illustrates an example of syntax of an EntityToGroupBox that may be used to describe a reference table through entities in an embodiment of the invention.

FIG. 19 illustrates the main steps of an example of a method for encapsulating media data according to embodiments of the invention;

FIGS. 20a and 20b illustrates the main steps of a method for generating the used properties description structure according to two different embodiments.

FIG. 21 illustrates the main steps of a method for describing a subsample in the subsample description box according to an embodiment of the invention;

FIG. 22 illustrates the main steps of a method for describing a subsample in the subsample description box according to another embodiment of the invention;

FIG. 23 illustrates the main steps of an example of method for reading encapsulated media data according to one of the encapsulation methods herein described;

FIG. 24 illustrates an example of syntax for a subsample description box according to an embodiment;

FIG. 25 provides an example of a SubSampleToGroupBox that may be used as a subsample description box.

### DETAILED DESCRIPTION OF THE INVENTION

Timed media data is encapsulated in tracks of samples, while untimed media data is encapsulated into items. While the wording “subsample” (or sub-sample) refers to samples, the subsample concept may apply to both samples and items. The subsample information box may be placed in a track to describe the subsample organization (or subsample information) of the samples of the track. It may also be placed into an item property container box to describe the subsample organization of an item. In the following, the description uses the wording sample in a generic way to refer to both track samples or items unless otherwise specified.

A subsample is a contiguous range of bytes inside a sample. The specific definition of a sub-sample (e.g. its type) is specific to each type of media data carried inside an ISOBMFF file. Depending on the kind of data a sample represents, a sub-sample may be a NAL unit (ISO/IEC 14496-15) from AVC, HEVC, VVC . . . or any NAL-unit based video codec, a Type-length-value unit or G-PCC unit (ISO/IEC 23090-18), any set of these units (e.g., decoding-unit-based, tile-based, slice-based or picture-based subsamples) or any arbitrary data chunk. We may use as a shortcut “data unit” to mention data corresponding to a sub-sample, whatever the type of data: NAL units, TLV units, etc. The possible types for a subsample depend on the codec format: for example, in video samples, a sub-sample may correspond to a picture, to a sub-picture, to a tile, to a slice or to a coding tree unit or to a NAL unit. As another example, for volumetric media data, a sub-sample may correspond to a Point Cloud frame, to a Point Cloud subframe, to a tile, to a slice or to a TLV unit.

A subsample description comprises different properties describing the subsample. A first type of properties is generic and present in all subsamples descriptions.

This is for example the case of the sub-sample size, that represents the number of bytes contained in a sub-sample. This information enables determining, for each sub-sample, it's byte-range inside a sample. This is realized by determining it's position inside a sample, by summing all previous sub-sample sizes information.

A second type of properties depends on the type of the subsample. This second type of property is only present in the description of the subsamples of that type of subsample. The type of subsample is typically associated with the codec used to encode the sample. The type of subsample or the type of subsample information or properties may then depend on a sample entry type and possibly on an additional property, for example on the flags value of the ‘subs’ box in ISOBMFF.

A subsample information box may be provided at the beginning of a media file (e.g. in the sample description of tracks described under a ‘moov’ box) or may be provided in movie fragments (e.g. in ‘traf’ boxes). It may also be provided as an item property when media data is described as data which does not require timed processing, as opposed to a timed sample data (e.g. as items in a ‘meta’ box).

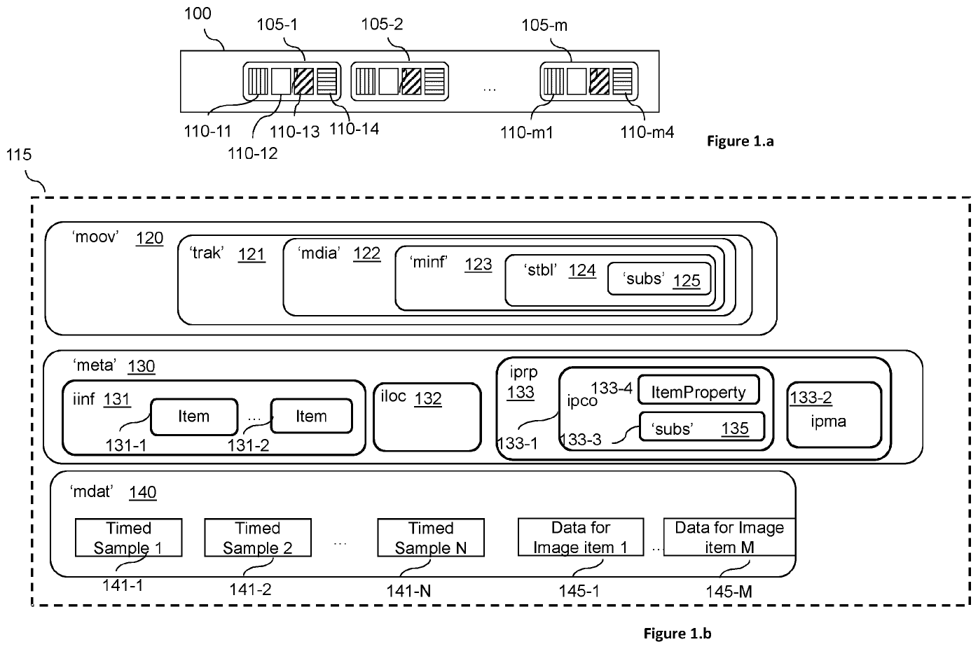

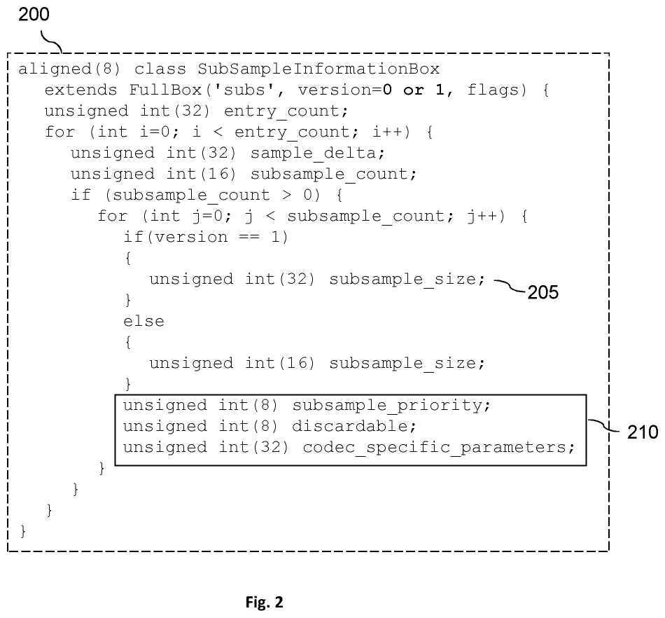

FIG. 1a illustrates an example of samples organized in subsamples in a media file. A bitstream 100 to be encapsulated using ISOBMFF file format, may be composed of several samples (e.g. frames for video, or items for a collection of images) 105-1 to 105-m. Each sample 105 may be the concatenation of several subsamples as for example the subsamples 110-11 to 110-14 for the sample 105-1 or the subsamples 110-m1 to 110-m4 for the sample 105-m. The subsample organization and content depend on the configuration of the encoder that generates the corresponding bitstream.

It may occur, due to the choice of the configuration or the encoder specification, that the organization into subsamples is the same for each sample and that therefore the description of the subsamples is repeated from one sample to the next.

It may be the case for example when using the point cloud file compression format as specified in ISO/IEC 23090-9, where samples 105-1 to 105-m may represent a point cloud frame. In that case, a frame is composed for example of one geometry data unit 110-11 (GDU) and several, three in the illustrated example, attribute data units (ADU) 110-12, 110-13 and 110-14. According to the point cloud compression specification, all the following frames 105-2 to 105-m shall also contain the same types of data units: one GDU and three ADUs. Therefore, the description of a subsample to specify the properties of the data unit it contains such as the type of the data units is repeated for all the samples.

This repetition of the subsample description may also occur in bitstream corresponding to other media types, such as for example video encoded pictures using the VVC (or HEVC) file format, when using sub-pictures or tiles during encoding.

For example, in the case of VVC, samples 105-1 to 105-m may describe a 1920*1080 video sequence, where each subsample describes a quarter of the video. Subsample 110-11 may describe the top-left part of the video frame 105-1. Subsample 110-12 may describe the top right of the video frame 105-1. Subsample 110-13 may describe the bottom-left part of the video frame 105-1, and subsample 110-14 may describe the bottom-right part of the same video frame 105-1. For each following sample the same sub-picture description may also apply. Therefore, in that case, the property that is repeated for each sample is the position of the sub-pictures it contains.

FIG. 1b illustrates an example of encapsulated media data organized as a non-fragmented media file according to the ISO Base Media File Format.

The media data encapsulated in the media file 115 starts with a FileTypeBox (‘ftyp’) box, not illustrated, providing a set of brands identifying the precise specifications to which the encapsulated media data conforms that are used by a reader to determine whether it can process the encapsulated media data. The ‘ftyp’ box is followed by a MovieBox (‘moov’) box referenced 120, a MetaBox ‘meta’ 130 and a MediaDataBox ‘mdat’ 140, which contains the media data (timed or untimed) that are described in the other metadata boxes.

The MovieBox box provides initialization information that is needed for a reader to initiate the processing of the encapsulated media data. In particular, it provides a description of the presentation content, the number of tracks, and information regarding their respective timelines and characteristics.

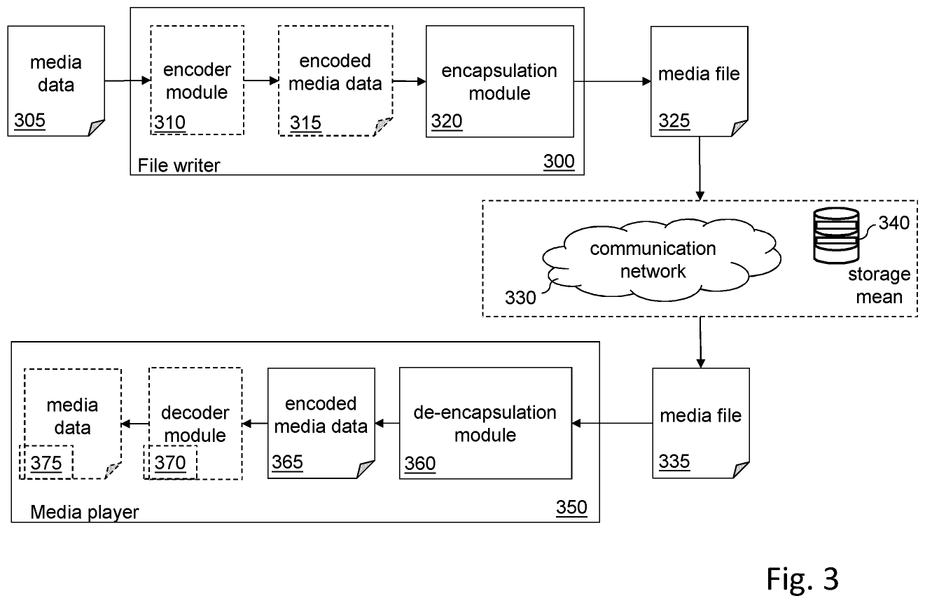

As illustrated, ‘moov’ box 120 also contains one (or more) TrackBox (‘trak’) boxes 121 describing each track in the presentation. TrackBox box 121 contains in its box hierarchy a MediaBox 122 (‘mdia’) that describes the creation date of the ISOBMFF file and the duration of the media data encapsulated. The ‘mdia’ box contains a MediaInformationBox (‘minf’) which in turn contains a SampleTableBox (‘stbl’) box. This SampleTableBox contains descriptive and timing information of the timed media samples 141-1 to 141-N contained in the ‘mdat’ 140. More particularly for subsample description, the SampleTableBox ‘stbl’ contains a subsample information box called SubSampleInformationBox (‘subs’) 125 which describes a contiguous range of bytes of a sample, enabling to know subsamples information such as their sizes as further described with FIG. 2.

The MetaBox ‘meta’ 130 comprises general untimed metadata including metadata structures describing one or more still images encapsulated as items. This ‘meta’ box 130 contains an ‘iinf’ box (ItemInfoBox) 131 that describes several single images. Each single image is described by a metadata structure ItemInfoEntry also denoted items 131-1 and 131-2. Each item has a unique 16-bit or 32-bit identifier item_ID. The media data corresponding to these items are stored in a container for media data, e.g., the ‘mdat’ box 140 (for example corresponding to samples 145-1 and 145-M). The media data may also be stored in an ‘idat’ box, in an ‘imda’ box or in another file. An ‘iloc’ box (ItemLocationBox) 132 provides for each item the offset and length of its associated media data in the ‘mdat’, ‘idat’, or ‘imda’ box. The media data for an item may be fragmented into extents. In this case, the ‘iloc’ box 132 provides the number of extents for the item and for each extent its offset and length in the ‘mdat’, ‘idat’, or ‘imda’ box.

ISOBMFF provides a mechanism to describe and associate properties with items. These properties are called item properties. The ItemPropertiesBox ‘iprp’ 133 enables the association of any item with an ordered set of item properties. The ItemPropertiesBox consists of two parts: an item property container box ‘ipco’ 133-1 that contains an implicitly indexed list of item properties 133-3 or 133-4, and an item property association box ‘ipma’ 133-2 that contains one or more entries. Each entry in the item property association box associates an item with its item properties.

The ItemProperty 133-4 and ItemFullProperty (here illustrated for ‘subs’ support 135) boxes are designed for the description of an item property. ItemFullProperty allows defining several versions of the syntax of the box and may contain one or more properties whose presence is conditioned by either the version or the flags parameter.

The ItemPropertyContainerBox 133-1 is designed for containing an implicitly indexed list of item properties (each inheriting from an ItemPropertyBox or ItemFullPropertyBox).

The ItemPropertyAssociation box 133-2 is designed to associate items and/or entity groups with item properties. It provides the description of a list of item identifiers and/or entity group identifiers, each identifier (item_ID) being associated with a list of item property index referring to an item property in the ItemPropertyContainerBox 133-1. As an example of item property that can be stored in the ItemPropertyContainerBox, there is the subsample information property defined in ISO/IEC 23008-12 defining the Image File Format, also known as High Efficiency Image File Format (HEIF). This subsample information property may benefit from the same optimization as those described hereafter for the ‘subs’ box from ISOBMFF.

The MediaDataBox ‘mdat’ 140 comprises the actual media data, here the data for timed samples 141-1 to 141-N described by ‘moov’ box and the data for items (data which does not require timed processing) 145-1 to 145-M described by ‘meta’ box. These samples or items may correspond to one of the samples described in FIG. 1a.

According to ISOBMFF, the media file 115 can be fragmented into a plurality of media files or fragments (i.e., a MovieBox ‘moov’ followed by a series of couple of MovieFragmentBox ‘moof’ plus MediaDataBox ‘mdat’ or of MovieFragmentBox ‘moof’ plus IdentifiedMediaDataBox ‘imda’).

According to ISOBMFF standard, the subsample information box (‘subs’) is not mandatory. Moreover, the ‘subs’ box allows a sparse representation of subsample information, avoiding describing subsample information for samples not containing subsamples of for which no subsample information is available.

However, the point cloud encapsulation specification ISO/IEC 23090-18 mandates the usage of the ‘subs’ box for single track and allows it as well for multi-track encapsulation of point cloud data. Therefore, for each sample of a point cloud as described previously in FIG. 1a, the ‘subs’ box contains repeated properties that increase the cost of the point cloud description in the file. This description cost issue is the main problem solved by this invention. Generally speaking, to solve this issue, various mechanisms are provided to reduce the redundancy that occurs when describing subsample information.

Moreover, this problem is not specific to point cloud (or volumetric media data) as explained previously with the usage of ‘subs’ box. It may also apply to VVC bitstreams for describing the organization of sub-pictures. Indeed, ISO/IEC 14496-15 may also use the ‘subs’ box for describing in ISOBMFF the organization in sub-pictures, by the codec_specific_parameters value when flags=4. In that case, even if the sub-picture organization is the same for the whole sequence contained in the bitstream, the content of the ‘subs’ box is not optimal as the same position for a sub-picture is repeated for each image of the video sequence. The syntax of the subsample information box ‘subs’ does not enable to avoid repetition of data that is common to multiple samples or subsamples. However, the size of the subsamples for consecutive samples have a low probability to be the same. This is due to the fact that subsamples typically contain encoded data where the size of the encoded data depends on the actual content of the data being encoded. This means that a description of each sub-sample, at least in terms of size, has generally to be provided. Based on these constraints, there is a need to improve the description cost of the ‘subs’ box.

FIG. 2 describes the content of the subsample information box ‘subs’ from the prior art.

The Subsample information box describes, for a set of samples, the characteristics of their subsamples, each subsample being a contiguous range of bytes of a sample.

The ‘subs’ box is specified with a version, which is an integer that specifies the version of the box. It enables a reader to check if it is able to support the description provided by the box. It is also used to provide different descriptions of the subsamples contained in a sample and for keeping backward compatibility with previous versions of the same standard.

Then, the entry_count is an integer that gives the number of entries (actually samples) that are described by the ‘subs’ box in the following loop.

For each sample, the ‘subs’ box specifies:
a sample_delta, that indicates how many samples are skipped. This element provides a means to skip one or more samples, for which subsample description does not exist. Therefore, the subsample descriptions use a sparse representation. sample_delta is an integer that indicates the sample having sub-sample structure. It is coded as the difference, in decoding order, between the desired sample number, and the sample number indicated in the previous entry.
a subsample_count, which is an integer that specifies the number of subsamples for the current sample. If there is no subsample structure, then this field takes the value 0. This provides another way to signal that a sample has no subsample information.

Then, for each sub-sample contained in the current sample, the ‘subs’ specifies:
the subsample_size 205 as an integer that specifies the size, in bytes, of the current sub-sample. This information is useful to access a particular sub-sample of a sample, knowing the cumulated sizes of the preceding subsamples for this sample (also known as byte-range).
a set of other characteristics 210, namely:
   a subsample_priority, that is an integer specifying the degradation priority for each sub-sample. Higher values of subsample_priority indicate subsamples which are important to, and have a greater impact on, the decoded quality.
   discardable that indicates when its value is 0 that the sub-sample is required to decode the current sample (otherwise the subsample is not required to decode the current sample but may be used for enhancements).
   codec_specific_parameters which specifies information about a sub-sample for a given coding system. For example, ISO/IEC 23090-18, depending on the value of the flags parameter, the codec_specific_parameters structure provides either (for flags=0) the type of G-PCC data unit which corresponds to the sub-sample (GDU/ADU), also known as G-PCC unit based subsamples, or (for flags=1) the tile identifier to which a subsample belongs (also known as Tile-based subsamples).

As another example, for VVC encoded video, ISO/IEC 14496-15 provides several specific codec_specific_parameters definitions. Among them, some of interest describes information to obtain the tile or the sub-picture position (for flags=2 or flags=4 respectively).

The set of characteristics 210 depends mainly on the configuration of the encoder, whereas the subsample_size depends on the content of the encoded media (either 2D video or point cloud (volumetric media data) in our examples). It is then most probable that for a fixed configuration, the set of characteristics 210 is the same for a given subsample from one sample to another. On the contrary, even with fixed configuration, the sizes of the subsamples may vary from one sample to another.

The invention proposes optimizations for the description of subsamples in a subsample information box that may be used to describe subsample information for track or item, based on the following ideas. It is proposed to identify some properties that are common among some subsamples or for a set of subsamples. The description of these common properties is made once, typically for the first subsample associated with these common properties. For the other subsamples associated with these common properties, the description of the subsample comprises a reference to the common properties. This reference may be a reference to a previous subsample. In this case, the common properties are implicitly stored in the referred subsample. Alternatively, an explicit description of the common properties is made in a new pattern box, and the reference refers to the corresponding pattern in this new pattern box for the subsamples or for the set of subsamples. Alternatively, the description of subsample's properties may be stored as a table in one or more dedicated boxes. The description of a subsample may then comprise a reference to an entry in the table.

The invention also proposes enhancements in the description of the subsample information box ‘subs’ to reduce the cost of its description adapted to the configuration of the bitstream.

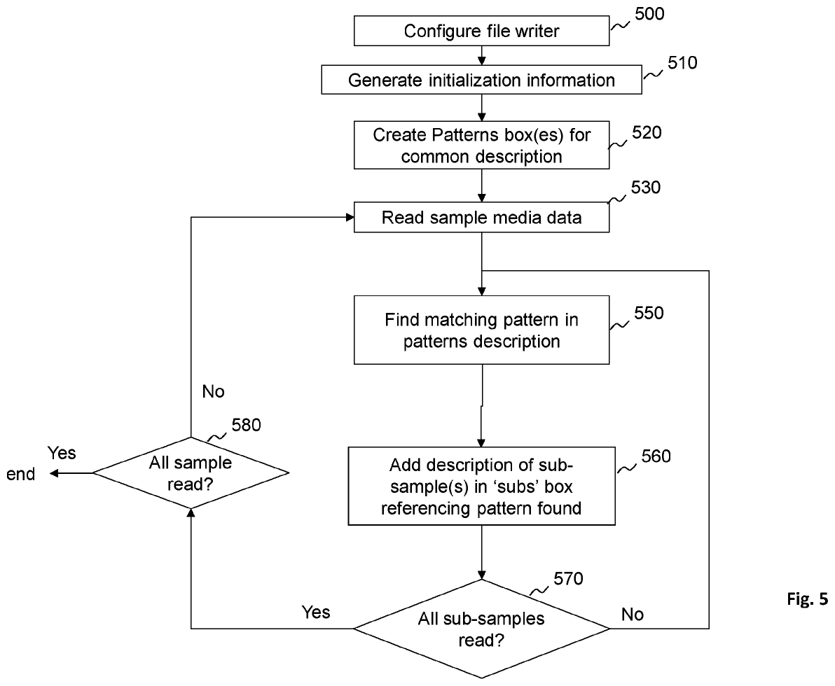

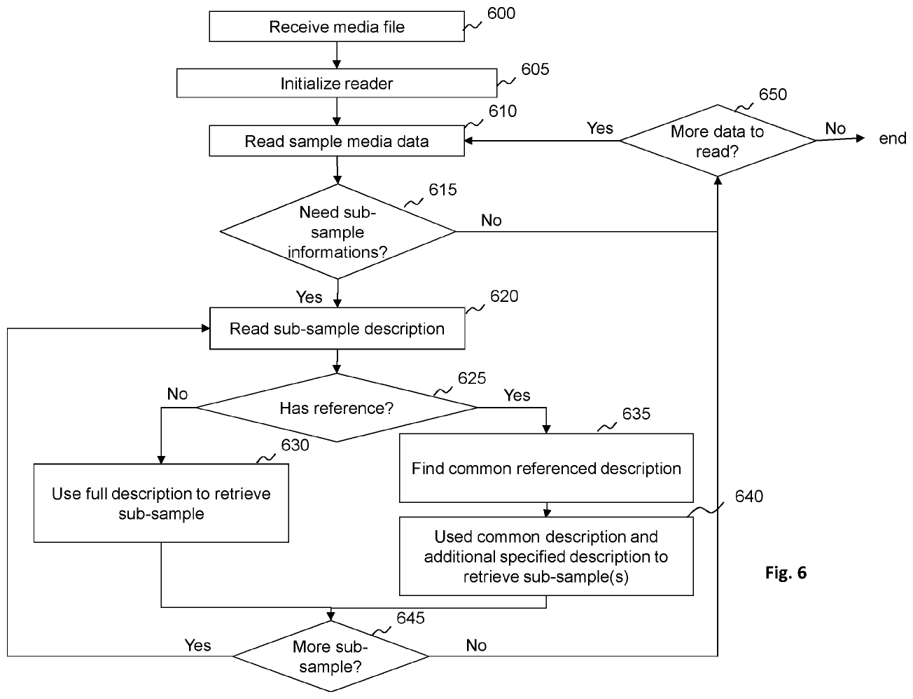

In reference to FIG. 2, the invention aims at grouping the description of similar properties in the set of characteristics 210 (called common properties in the rest of this document), and at using different reference mechanisms to use a single description of these properties for specifying as many subsamples as possible. The main advantage of using a reference mechanism is the reduction of the size of the ‘subs’ box inside a track or inside a collection of items of an ISOBMFF file. The different mechanisms improving ‘subs’ box are described in relation with FIG. 4 and FIG. 5.

It is to be noted than more than one SubSampleInformationBox (‘subs’) may be present in the same container box, assuming the value of the flags parameter differs in each of these ‘subs’ boxes. Therefore, the reference mechanism introduced by the invention may be used to optimize independently different ‘subs’ boxes, corresponding to different common properties.

In some embodiments, it may happen that even the size is the same for several sub-samples. For example, raw image data or uncompressed point cloud, which means not encoded image data or point cloud, may be split in tiles with a same size for each tile. In this case, the sub-samples corresponding to tiles data in the sample may all have the same size. In that case, a whole subsample may be described by reference. This may for instance be achieved by considering, each time a subsample is described by reference, an additional Boolean value (to the has_reference parameter) indicating whether the reference also describes the subsample size or not.

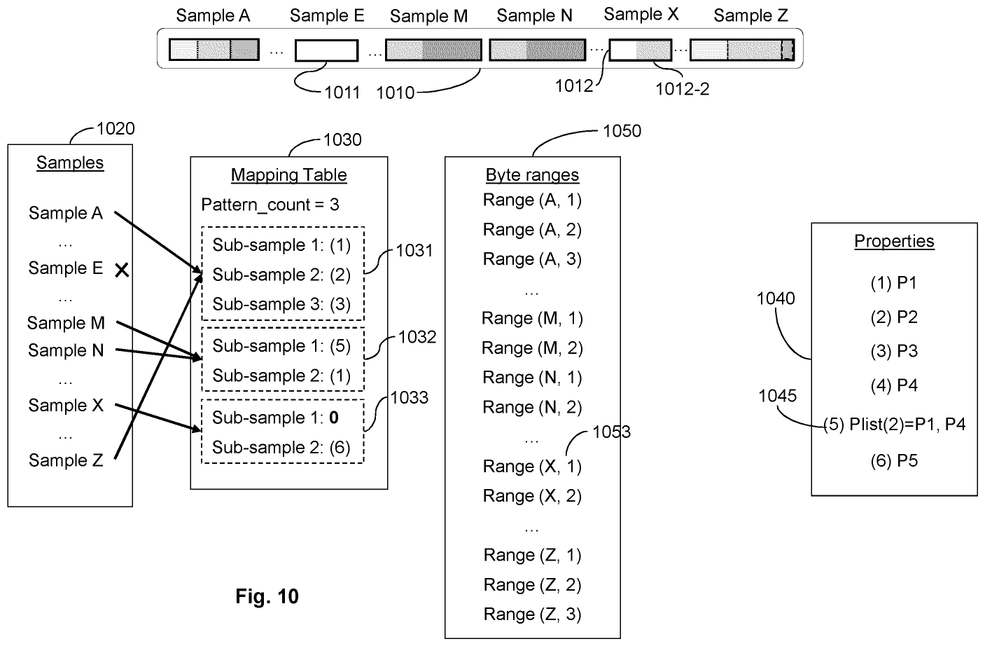

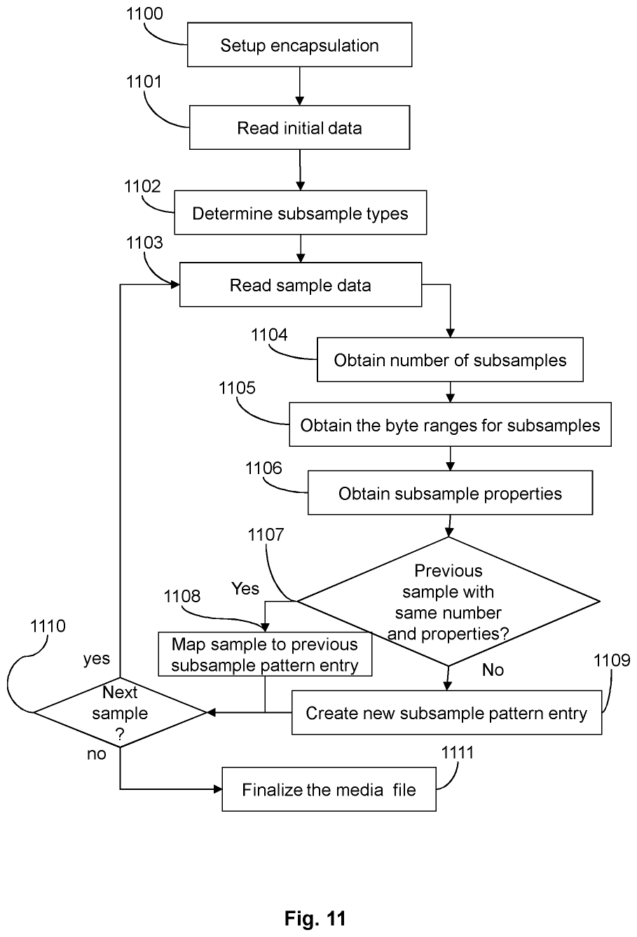

An alternative to the ‘subs’ box, using a mechanism to store common properties and to associate subsamples to these properties is described in relation with FIG. 10 and FIG. 11.

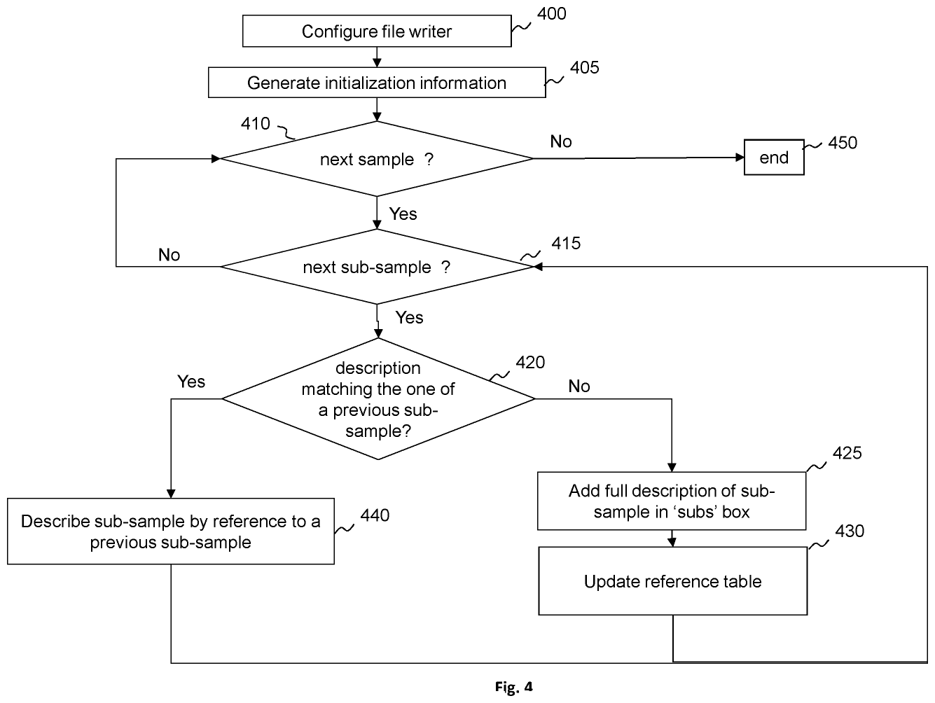

FIG. 3 is an example of a system for the encapsulation or storage of multimedia presentations, where the proposed method for describing subsamples may be used.

The file writer 300 takes as input the media data 305. The file writer 300 processes the media data 305 to prepare it for streaming or for storage. This step is called media encapsulation. It consists in adding metadata describing the media data in terms of kind of data, codec in use, size, data offsets, timing . . . . The media data 305 may be the raw data captured by sensors or may be data generated by a content creator or editing tools. For example, the input media data 305 can be video data, point cloud data or sequence of images. The media data 305 may otherwise be available as compressed or encoded media data 315, possibly as different encoded versions. For example, for point cloud media data, the data may be compressed using the MPEG-I Part-9 standard. As another example, for video/image data, the data may be compressed using VVC/HEVC or any other video/image compression standard. This means that the encoding or compression may be performed by the file writer itself using the encoder module 310 (possibly one per media type) or may be performed outside of the file writer. The compression may be live encoding (as well as the encapsulation). The file writer 300, through the encapsulation module 320, encapsulates the media data into movie file, movie fragments, for example according to ISOBMFF and its extensions (e.g. possibly NAL-unit based File Format for video data, MPEG-I Part-18 for point cloud data). The file writer 300 then generates a media file 325 or one or more segment files 325. The file writer 300 may optionally generate a streaming manifest like a DASH MPD or HLS playlist (not represented). The generated file 325, segment files or manifest may be stored on a network (340) for redistribution via on demand or live streaming.

The encapsulation process is further described in reference to FIG. 4 or FIG. 5, implementing the proposed methods for describing subsamples.

The file writer 300 may be connected, via a network interface (not represented), to a communication network 330 to which is also connected, via a network interface (not represented), to a media player 350 comprising a de-encapsulation module 360.

The media player 350 is used for processing data received from communication network 330, or read from a (local or remote) storage device, for example for processing media file or media segments 325. The data may be streamed to the media player, thus involving a streaming module (not represented) in charge of parsing a streaming manifest and of determining requests to fetch the media streams and of adapting the transmission, according to indication in the manifest and media player parameters like for example available bandwidth, CPU, application needs or user preference. The received data is de-encapsulated in the de-encapsulation module 360 (also known as a ISOBMFF parser or as an ISOBMFF reader or simply as a parser or as a reader), the de-encapsulated data (or parsed data) may be decoded by a decoder module for storage, display or output to an application or to a user(s). The decoder module (possibly one or more per media type) may be part of the media player or may be an external module or dedicated hardware. The de-encapsulated data often correspond to encoded media data 365 (e.g. video bitstream, point cloud bitstream . . . ). The de-encapsulation, decoding and rendering may be realized as a live processing of the media file while it is being received, for example by processing data chunks for each media stream in parallel and in synchronized manner to minimize the latency between the recording of the media (i.e. media data 305) and its display to a user as media data 375.

It should be noted that the media file 325 may be communicated to the media player 350 in different ways. In particular, the file writer 300 may generate a media file 325 with a media description (e.g. DASH MPD) and communicate (or stream) it directly to the media player 350 upon receiving a request from media player 350. The media file 335 may also be downloaded, at once or progressively, by the media player and stored alongside the media player 350.

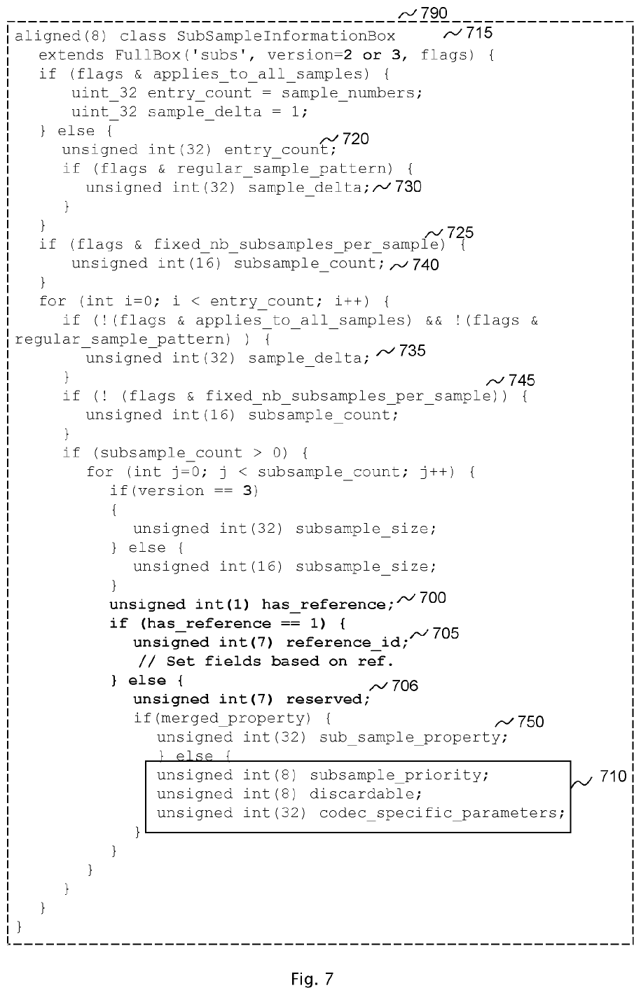

The parsing process performed by the de-encapsulation module 360 is further described in reference to FIG. 6.

FIG. 4 and FIG. 5 describe in more details the encapsulation process according to different embodiments of the invention.

FIG. 4 illustrates the encapsulation process according to one embodiment of the invention. This process is performed by the encapsulation module 320.

The process starts in step 400 by configuring the file writer 300. This configuration may set up some parameters for the encapsulation module 320. This step may consist in setting a number of tracks or items. For example, for point cloud encapsulation, it may consist in defining the use of single-track encapsulation where all samples contain G-PCC data units (GDUs and corresponding number of ADUs), requiring the description of G-PCC unit based subsamples by a ‘subs’ box with flags=0. For VVC, it may also set the number of tracks to 1, where each sample will contain NAL units corresponding to several sub-pictures and where the ‘subs’ box with flags=4 will be used to describe the relative position of sub-pictures in the full picture. The configuration may also impact the encoder module 310. The encoder settings may define, for example in the case of a video stream, the number of sub-pictures and therefore the number of sub-samples that are contained in a sample. For a point cloud, they may specify the number of attributes encoded and therefore the number of ADUs data units present for one GDU in each sample. This configuration may also comprise settings indicating whether the number of sub-frames per frame is fixed or not, whether the settings apply to all the samples (or items) of the sequence or only to some samples, for example at regular time intervals. These parameters may be hard-coded in the file writer 300 or specified by the user, for example through a command line, control scripts or through a graphical user interface.

After the configuration of the encapsulation module, metadata structures of a media file such as top-level boxes (e.g., ‘ftyp’ or ‘styp’, ‘moov’, ‘mdat’) and contained sub-boxes for track and sample description like ‘trak’, ‘stbl’, ‘stsd’, etc) are created during an initialization step (step 405). Such an initialization step may comprise reading parameter sets (e.g. geometry and attribute parameter sets) from an encoded bitstream of point cloud data or may comprise obtaining information about the sensor (for uncompressed data) like a number of points, the types of attributes associated with the points (e.g., colour, reflectance, timestamp, areas of interests, etc.). For an encoded bitstream of video data, the initialization step may read sequence parameter sets or picture parameter sets to obtain for example the size (height and width) of the image and of any sub-pictures that may be present when the sequence is not encoded by the file writer but received from an external encoder. It is to be noted that some of the setting parameters defined in the configuration step 400 may be reflected in the track descriptions or the sample descriptions.

According to this embodiment of the invention, during the initialization step 405, an empty SubsampleRef array is created, to store common properties. This array typically has a maximum capacity, for instance a predetermined size of 128 entries. Each entry in said array may comprise a set of values for subsample_priority, discardable and codec_specific_parameters, a number of occurrences, and an appearance index. Considering the number of occurrences and appearance index allows, as described hereafter, to preserve entries that are more likely to be used as references.

Then, the encapsulation process is realized by checking if there is still a remaining sample to be read from the bitstream (step 410). If this is the case, the process reads one sample of the media bitstream, starting from the first remaining one. During the read operation of the sample, the file writer determines if the sample contains subsamples or not. For a point cloud compressed sample, the presence of subsamples may be determined by parsing the data unit header (also called TLVs) and determining from the header the type of the current data unit (GDU, ADU, parameter set) and the size of the unit in bytes. Then, the location of a next data unit of the sample may be determined, and the number of subsamples present in a sample may be determined. For a video sequence, a similar process may be realized using the NAL unit header to identify the type of the current data unit and searching for specific delimiter code in the bitstream, to determine the size and location of the next data unit in the sample. At the end of this step, the file writer has determined if subsamples are present or not in the current sample. Moreover, if the sample contains subsamples, the file writer has determined the number of subsamples and the characteristics of the subsamples such as for example their types and their sizes. These data are then stored in a SubsampleArray structure in memory. If there is no subsample, the SubsampleArray structure is empty.

If step 410 determines that there are no more samples in the bitstream, then the ISOBMFF file is finished (step 450), possibly with creation of some boxes for indexing or random access.

When the test 410 returns true, then the process checks in step 415 if there are still subsamples to describe for the current sample.

If there are no remaining subsamples, then the next step of the process is step 410, skipping all operations performed to describe subsamples. This may be the case when a sample does not contain any subsamples or for which the encapsulation setting does not require generating a subsample description.

This may also be the case when the last subsample of the current sample, has been processed.

When subsamples are present (test 415 true), starting from the first subsample, step 415 reads a new sub-sample from the SubsampleArray to start the creation of the Subsample information box of the ISOBMFF file for the current sample.

If step 415 is positive, in step 420, the file writer 300 may then check if the current subsample description matches the description of a previous subsample, meaning that a set of common properties may be identified between the current sub-sample and any of the previous ones. This may be performed by checking if one of the stored set of common properties inside the SubsampleRef array corresponds to the values of corresponding characteristics of the current sub-sample and may therefore be used as a reference for the description of the current sub-sample.

If no previous subsample reference is found (i.e. when the check of step 420 is negative), then steps 425 and 430 are performed for the current sub-sample. It results in adding another new element describing the current sub-sample in the ‘subs’ box and in the SubsampleRef array. Step 425 adds the full description of the sub-sample to the ‘subs’ box. Step 430 adds this description to the SubsampleRef array in order to be able to use it for describing following subsamples sharing the same properties. Typically, this may first consist in creating a new entry based on the values of subsample_priority, discardable and codec_specific_parameters, with a number of occurrences of 0, and an appearance index equal to number of sub-sample previously processed. Then, as a second step, if the array has a maximum capacity, it is then checked whether said maximum capacity has been reached. If not, the new entry is appended to the table. On the other hand, if the maximum capacity has been reached, it is necessary to remove an existing entry prior to adding a new one. In this context, it is advantageous to put the new entry in place of the entry with lowest number of occurrences (1st criterion) and lowest appearance index (2nd criterion). This method of managing the array of reference is provided as an example. Other methods may be used, for instance by enabling the writer to explicitly indicate which subsamples should be considered for addition to the array of references.

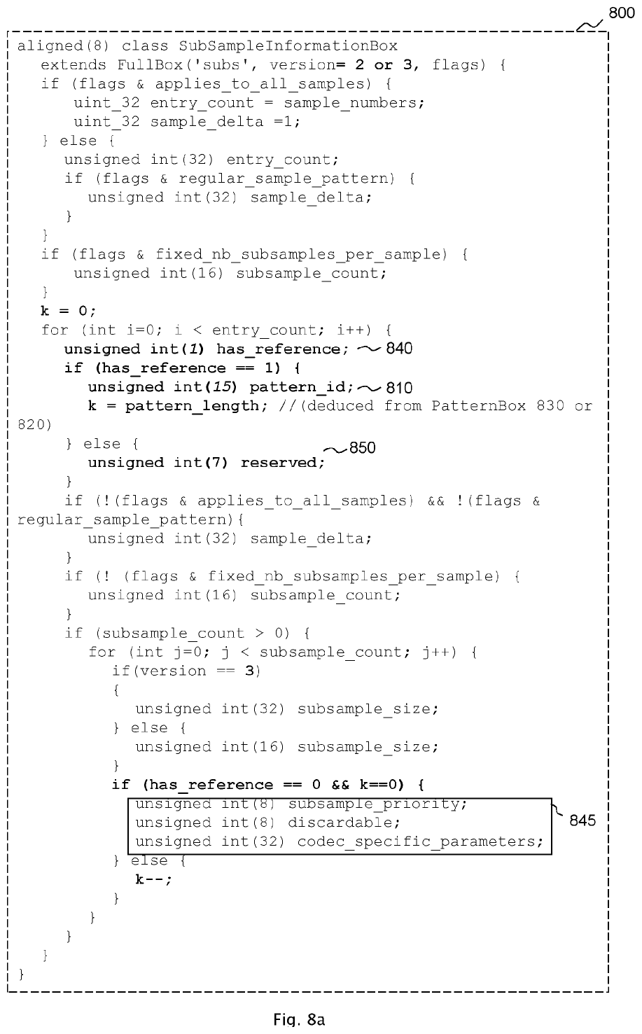

Otherwise, when the step 420 is positive, at step 440, a new description is added to the SubSampleInformationBox for describing the current sub-sample. This description takes advantage of the stored common properties of a previous subsample found (in the SubsampleRef array at step 420). This description refers to the previous subsample to signal the common properties of the current sub-sample and define any additional information such as the size of the sub-sample. For example, the reference may be specified using the corresponding index in the SubsampleRef array. The syntax to indicate whether the subsample is using a reference or not and which set of common properties is used is further described in relation with FIG. 7. It is to be noted that a reference to a previous subsample corresponds either to a sub-sample of the same sample or to a sub-sample of any previous samples or any previous samples that are not before a sync sample (to guarantee random access). This provides more possibilities to group common properties between all subsamples.

At this step, the number of occurrences of the entry in the SubsampleRef array found at step 420 is increased by one. The appearance index of this entry is set to the number of subsamples previously processed.

After any of the steps 430 or 440, the step 415 is realized again. If another subsample exists for the current sample, it is processed by steps 420 to 440. Otherwise, if there are no more subsamples for the current sample, the process goes to step 410.

Possibly, the replaced entry at step 430 may be selected differently. For example, it may be selected using only the lowest appearance index.

Possibly, the number of occurrences and the appearance index are not stored in the SubsampleRef array. Instead, the SubsampleRef array is kept ordered according to the selection criteria used to decide which entry to replace in it. For example, at creation, a new entry is added at the end of the SubsampleRef array. At step 440, the entry used as a reference is moved at the end of the SubsampleRef array. At step 430, when the SubsampleRef array has reached its maximum capacity, its first entry is removed.

Possibly, the SubsampleRef array may be reset to an empty array during the encoding. For example, the SubsampleRef array may be reset to an empty array when a random access point is created for the media to allow a reader to parse the ‘subs’ box without having to reconstruct the content of the SubsampleRef array from the beginning.

FIG. 7 describes a first syntax embodiment of a subsample information box to support reference to a previous subsample and reusing its properties.

The syntax of the new SubsampleInformationBox is shown in 790, as proposed for the support of the invention, uses new version values 2 or 3 to enable the optimization of the ‘subs’. Using new values for the version parameter enables to keep a backward compatibility with the ‘subs’ box as defined in the standard. Optionally, each of these new versions may also be used with new semantics for the flags parameter, as described hereafter to support additional improvements of the ‘subs’ box.

For using the syntax shown in 790, the flags parameter 715 is defined as a generic part (for example the first byte) and a codec-specific part (for example the two last bytes). Each part defines its own set of values. For example, the new generic part defines the following values:
applies_to_all_samples: Flag mask is 0x800000. When set, this value indicates that the subsample information box applies_to_all_samples of the track or track fragment (this avoids repeating a sample_delta always equal to 1).
regular_sample_pattern: Flag mask is 0x400000. When set, this value indicates that the sample_delta always takes the same value and is declared only once in the SubsampleInfomationBox.
fixed_nb_subsamples_per_sample: Flag mask is 0x200000. When set, this value indicates that the subsample_count can be encoded once for all samples having a subsample description and is not repeated in the loop of entries.
merged_property: Flag mask is 0x100000. When set, this value indicates that the ‘subs’ box uses an optimized syntax for the coding of the set of characteristics 210.

The usage of the flags applies_to_all_sample, regular_sample_pattern, fixed_nb_subsamples_per_sample and merged property is described later and introduces additional optimizations that may apply to any of the embodiments described here. In the following, they are supposed to be set to 0. The last two bytes may be used by derived specifications to define their own flags values, for example to identify the type of the subsamples (NAL units, pictures, tiles, subpictures, slice, G-PCC units, G-PCC tiles, G-PCC slices, G-PCC sub-frames . . . ).

In that case, syntax element (or parameter, or field) 700, 705, 706 and 710 are present in the description of subsamples when using the process of FIG. 4.

The element 710 is used for the description of subsamples that do not refer to any previous subsamples. In that case the description of a sub-sample is the same as the one of FIG. 2.

The elements 700, 705 and 706 are the new syntax elements enabling the description of a subsample by referencing a previous subsample.

First the flag has_reference 700 enables signaling how a subsample is described. If the value of this parameter 700 is 0, then the description of the subsample uses the element 710. If the value of this parameter 700 is 1, then the description of the sub-sample is realized by referring to a previous subsample.

Then, when a subsample refers to a previous one, the value of the parameter reference_id 705 indicates the index of the SubsampleRef array, containing the common properties.

The parameter reserved 706 may be added to keep the byte alignment of description 710 as required by the ISOBMFF standard. Its value may be set to 0.

Using this syntax has the advantage to allow referring to any previous subsample of the bitstream, from the same sample or from any other sample, or for any other sample that is not prior the previous sync sample (to guarantee random access).

A first alternative to this embodiment may avoid adding the reserved 706 field, by reducing the size of the subsample_size by one bit, using for example the following syntax (new or modified elements are shown in bold):

```
for (int j=0; j<subsample_count; j++) {
  if (version==3) {
    unsigned int(31) subsample_{—}size;
  } else {
    unsigned int(15) subsample_{—}size;
  }
  unsigned int(1) has_reference;
  if (has_reference) {
    unsigned int(8) reference_id;
  } else {
    unsigned int(8) subsample_priority;
    unsigned int(8) discardable;
    unsigned int(32) codec_specific_parameters;
  }
}
```

In this case, the size of the reference_id value is increased by 1 bit.

A second alternative for this embodiment may enable referencing not only a single subsample but a set of one or more subsamples, by using an internal counter and a pattern length, for example using the following syntax (new or modified elements are shown in bold):

```
int k=0
for (int j=0; j<subsample_count; j++) {
  if (version==3) {
    unsigned int(32) subsample_size;
  } else {
    unsigned int(16) subsample_size;
  }
  If (k==0) {
    unsigned int(1) has_reference;
    if (has_reference) {
      unsigned int(7) pattern_{—}length;
      unsigned int(8) reference_id;
      k = pattern_{—}length;
    } else {
      unsigned int(7) reserved;
      unsigned int(8) subsample_priority;
      unsigned int(8) discardable;
      unsigned int(32) codec_specific_parameters;
      k = 1;
    }
  }
  k--;
}
```

In this embodiment, a length is signaled in addition to the reference_id in order to indicate that a new sequence of subsamples is described by referencing a previously met sequence of subsamples. The first new subsample is described in reference to the subsample associated with reference_id, and next N following subsamples are described by reference to the N subsamples occurring after the subsample associated with reference_id. In this case, the pattern_length variable is therefore typically equal to N+1 given that the described sequence of subsamples has a length of N+1. If the currently described subsample is not defined using a reference, to keep the byte alignment a reserved (7 bits) field is added to the description. Its value may be set to 0 by default.

Alternative conventions may be chosen for describing the pattern length. For instance, it may be decided that pattern_length should not comprise the first subsample, i.e. be equal to N. As another variant, reference_id may be represented on 6 bits, so that 1 bit may be used to indicate whether a pattern length is indicated or not: if the bit value is 0, no pattern length is added, which means that a single subsample is described through this reference; on the other hand, if the bit value is 1, a pattern length is indicated on 8 bits. In yet another variant, the pattern_length and the reference_id may be stored on 7 bits, for instance using 4 bits for the reference_id and 3 bits for the pattern_length. This limits the range of possible values, but it allows a more compact representation, which may be a better trade-off depending on the considered data.

For this alternative, improvements described for the first alternative may also apply.

When using this alternative, the SubsampleRef array used by the steps described in reference to FIG. 4 may contain some pattern usage information to prevent replacing an entry in the middle of an often used sequence of entries. For example, a pattern_usage value may be stored for each entry and may be increased each time the entry is referred to as part of a pattern. This pattern_usage value is then used as the first criterion for deciding which entry to replace inside the SubsampleRef array, selecting the entry with the smallest pattern_usage value.

Possibly, the number of occurrences, the appearance index and the pattern_usage are not stored in the SubsampleRef array. Instead, the SubsampleRef array is kept ordered according to the selection criteria used to decide which entry to replace in it. In this alternative, when several entries are referenced at once as a pattern, all these entries are moved as a block at the end of the SubsampleRef array.

A third alternative may be used when each sample has a similar set of subsamples, the subsamples differing only through their sizes. This alternative enables to describe the common properties of the subsample once, using for example the following syntax for the subsample information box (this syntax may be enclosed as a new version of the box):

```
aligned(8) class SubSampleInformationBox extends FullBox(‘subs’,
version=2 or 3, flags) {
  unsigned int(16) subsample_count;
  for (int i = 0; i subsample_count; i++) {
    unsigned int(8) subsample_priority;
    unsigned int(8) discardable;
    unsigned int(32) codec_specific_parameters;
  }
  unsigned int(32) entry_count;
  for (int i = 0; i < entry_count; i++) {
    for (int j = 0; j < subsample_count; j++) {
      if (version == 3) {
        unsigned int(32) subsample_size;
      } else {
        unsigned int(16) subsample_size;
      }
    }
  }
}
```

In this alternative, a first loop describes the properties of the subsamples for all the samples. Then a second loop describes the size of each sub-sample for each sample.

In this case, only the subsample_size parameter is specified for each sub-sample and the cost of the repetition of the common properties is reduced.

An improvement to describe the size of a subsample that refers to a previous subsample, applicable to any previous alternative description, may be to encode the size of the sub-sample as a difference with the size of the referred to subsample. For example, subsample_size_delta parameter, encoded as a signed integer, may encode this difference. The size of the sub-sample is the sum of the value of the subsample_size_delta parameter and of the value of the subsample size for the referred to subsample. This subsample_size_delta parameter may be specified in place of the subsample size parameter.

FIG. 5 illustrates the encapsulation process according to a second embodiment of the invention. This process is performed by the encapsulation module 320. According to this embodiment, common parts in the subsample descriptions are stored in a dedicated box. The description of the subsamples may refer to these common parts. In the following, these common parts are called patterns and the dedicated box is referred to as a pattern box, identified by a dedicated four-character code (for example ‘sspb’ for Sub-Sample Pattern Box or ‘sspc’ for Sub-Sample Pattern Container).

The process starts at step 500 by configuring the file writer 300. This step is similar as the one described in step 400 of FIG. 4.

Then, step 510, similar to step 405 of FIG. 4, initializes the information for the generation of some of the boxes of the ISOBMFF file 325.

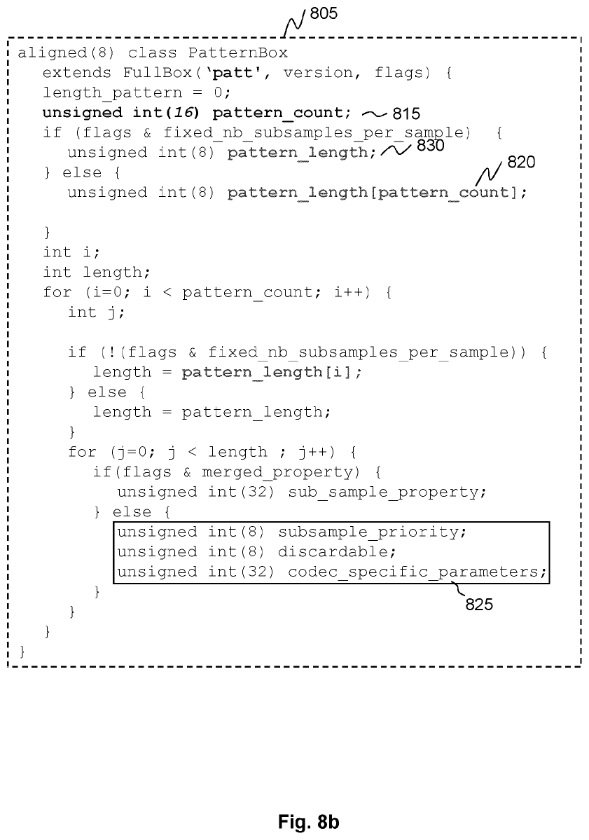

The next step 520 is then realized, to create a new PatternBox description structure used to store common properties. The syntax of this pattern box is described hereafter in relation with FIG. 8b. The PatternBox when added to an ISOBMFF file, may apply to all the samples of the described bitstream. Therefore, it may appear in the box hierarchy inside a ‘moov’ box, or in a ‘stbl’ box. This PatternBox may be identified by a 4CC ‘patt’ or ‘patb’ or any dedicated 4CC for description of subsample pattern that do not conflict with any existing 4CC.

In a variant, the PatternBox may also be defined in the box hierarchy inside a MovieFragmentBox ‘moof’ similarly to the SubSampleInformationBox to apply only on the samples of the fragment. The same 4CC ‘patt’ or ‘patb’ may be used.

In a variant, the PatternBox may only apply to a group of samples, e.g., using the ISOBMFF sample group mechanism. The PatternBox can be defined as a SampleGroupDescriptionEntry in a SampleGroupDescriptionBox.

The PatternBox description structure is created depending for example on the encapsulation mode (single-track or multi-tracks) and on the characteristics of the bitstream such as the number of attributes for point cloud data or the number of sub-pictures for a video bitstream. This information is either provided as input through the user interface (in the case where the encoder is integrated in the file writer) or determined by reading parameter sets of the bitstream to encapsulate.

For example, for the encapsulation of a point cloud bitstream, the number of attributes may be detected by parsing information from the sequence parameter set. Knowing the number of attributes (noted nb_adus), determining the number of subsamples for one sample of a single point cloud frame is done as follows. It corresponds to one geometry data unit plus the number of attribute data units as point cloud bitstream compliancy requires all attribute data units to be present (either by an ADU or a defaulted ADU). In the case of several point cloud frames (for example when concatenating the point clouds captured by N different LiDARs in the same bitstream), a sample will contain N*(1+nb_adus) subsamples.

It is then possible to determine a subsample pattern describing common properties in the PatternBox. The subsample patterns in the PatternBox may be determined using different methods. A first method may determine exhaustively all the possible subsample patterns based on the considered technology, without parsing the bitstream to encapsulate. If said technology allows many types of subsamples, the number of patterns may be high, resulting in a significant description cost. Therefore, a second method may only determine a subset of the most likely patterns to be used as reference description based on generic assumptions for the considered technology (e.g. consider only the most frequently used subsample types). Finally, a third one may dynamically detect patterns while parsing the bitstream and may determine which patterns to store in the pattern box to minimize the description size.

As another example, for video bitstream encapsulation, the number of sub-pictures could be set by the user and the configuration of the encoder may require using one NAL unit per sub-picture. Therefore, for the video encoded bitstream, the number of subsamples may correspond to the number of sub-pictures. Then a PatternBox may be determined in order to store the common properties applying to any of the sample of the bitstream.

The patterns may also be provided using a different granularity for subsample description. A first granularity may define patterns used for the whole sample, which may be of interest when all samples are encoded in the same way. A second granularity level may only describe a set of contiguous subsamples inside a sample.

Then in step 530, the encapsulation process is realized by reading one sample of the media bitstream starting from the first one. Similarly to step 410 of FIG. 4, during the read operation of the sample, the file writer determines if the sample contains or not subsamples. At the end of this step, the file writer has determined if subsamples are present or not in the current sample. Moreover, if there are some subsamples, it has determined the number of subsamples and the characteristics of the subsamples such as for example the type and the size of each sub-sample. This information is then stored in a SubsampleArray structure in memory.

If there are no subsamples, then the next step of the process is step 580, skipping all operations performed to describe subsamples. (not represented for simplification)

When subsamples are present, the process determines during step 550 the pattern of the PatternBox that corresponds to this set of subsamples. For this, knowing the length N of each pattern, the process checks for each pattern if the set of characteristics of the N following subsamples, starting from the current sub-sample, matches the common properties of the pattern description. Length N is obtained from the pattern_length parameter, described in relation with FIGS. 8a and 8b.

When an exhaustive description of all the possible patterns is contained in the PatternBox, one pattern matching a sequence of subsamples starting at the current sub-sample will always be found. In the case where the PatternBox defines only a subset of all the possible patterns, it may happen that no reference is found for the sequence of subsamples. In this case, the sequence of subsamples is described directly inside subsample information box without any reference to a pattern, for example using the same description as in the prior art.

In all cases, during the next step 560, the file writer 300 adds to the subsample information box (125 or 135) the information describing the current set of subsamples as later explained in relation with FIGS. 8a and 8b, using or not reference to common subsample(s) description(s) provided in the PatternBox.

Then in step 570, it is checked whether all the subsamples of the current sample are described in the subsample information box. It may be done by verifying that the processing of the sample has reached the end of the sample. If the test is negative, there is still some subsample information to add for describing the sample, and step 550 is realized again for processing the remaining subsamples. Otherwise, all the subsamples have been described and added in the ‘subs’ box. Another check in step 580 is realized to check whether there are more samples to add to the ISO Base Media file.

If another sample is present (test 580 positive), then steps 530 to 570 are realized for processing the next sample and its subsample descriptions. Otherwise, the creation of ISO Base Media file ends, possibly with creation of boxes for indexing or random access information.

FIGS. 8a and 8b illustrates a first syntax embodiment of a subsample information box to support reference to an explicit pattern description and its common properties.

The subsample information box syntax 800 as proposed for the support of the invention, uses new version values 2 or 3 to enable further optimizations of the ‘subs’ using specific semantics for the flags parameter as described for the element 790 of FIG. 7. The version parameter also enables to keep a backward compatibility with previous definition of the ‘subs’ box.

The usage of the flags applies_to_all_sample, regular_sample_pattern, fixed_nb_subsamples_per_sample and merged property is described later on and may apply to any other described embodiment. For this section, these generic flags value are not set.

In this case, the syntax elements 810, 840 and 845 in the subsample information box, and the PatternBox 805 are present in the ISOBMFF for supporting the process of FIG. 5.

In the subsample information box, the element 845 is used for the description of subsamples that do not refer to any pattern from the PatternBox. In this case the description is the same as the one of FIG. 2. This may occur in case a non-exhaustive pattern description is done in step 520. This enables to reduce the PatternBox size and enables to support samples containing additional parameter set data units or occasional data units (such as Tile inventory data unit for point cloud). In this case, the parameter has_reference 840 is set to 0.

The elements 840 and 810 are the new syntax elements in the subsample information box enabling to reference a set of common properties 825 contained in the PatternBox 805.

First the flag has_reference 840 enables to differentiate between the description of a set of subsamples where all the description 845 is comprised in ‘subs’ box (when set to 0) and one that refers to a pattern described in the additional PatternBox (when set to 1).

Then, when the set of subsamples refers to a pattern, the value pattern_id 810 indicates the identifier of the corresponding description in the PatternBox, which contains the common properties 825. Said identifier is typically the index of the pattern in the PatternBox.

The parameter reserved 850 is added to keep the byte alignment of the description 800 when the subsample has no reference to the PatternBox.

The PatternBox as described in 805 enables to support a granularity for subsample description at the sample level. It defines patterns used for a whole sample as declared in the loop over the entry_count value that corresponds to a sample. When setting the pattern identifier 810, counter k is initialized to the pattern_length value of the corresponding pattern description in the PatternBox (defined in step 520). Then this counter enables to determine, inside the pattern, to which common properties a subsample is referring to.

In an alternative, to support description of a subset of subsamples inside a sample, the information 840, 810 and 850 may be removed from the entry_count loop and may be declared in the subsample_count loop as follow (introduced new features are indicated in bold):

```
for (int j=0; j<subsample_count; j++) {
  if (version==3) {
    unsigned int(32) subsample_size;
  } else {
    unsigned int(16) subsample_size;
  }
  if (k==0) {
    unsigned int(1) has_{—}reference;
    if (has_{—}reference==1) {
      unsigned int(15) pattern_{—}id;
      k = pattern_{—}length;
    } else {
      unsigned int(7) reserved;
      unsigned int(8) subsample_priority;
      unsigned int(8) discardable;
      unsigned int(32) codec_specific_parameters;
      k = 1;
    }
  }
  k--;
}
```

In another alternative, the pattern_id parameter may be repeated for each sub-sample in the pattern and the implicit position inside the pattern is computed to determine to which set of common properties a subsample is referring to.

In another alternative, when an exhaustive pattern description is used in the PatternBox, the has_reference flag may be omitted and, only the pattern_id parameter may be present (either for all samples or set of subsample description). In this case the pattern_id parameter may be encoded using 16 bits. Indeed, in that case all samples necessarily refer to a pattern, hence implicitly has_reference is always 1.

The PatternBox syntax 805 proposed for pattern description may use the codec-specific part of the flags parameter 715 to make association between the subsample information box 800 and the referenced PatternBox 805. It enables to support different subsample information corresponding to different sets of common properties 825.

The PatternBox may comprise, for example, the following syntax elements:
pattern count 815 defines the number of patterns described in the PatternBox.
pattern_length 820 defines the size of the pattern description. It enables to support different sizes of patterns for a sample, for a sequence of subsamples inside a sample or for a sequence of sub-samples spanning one or more samples.

The common properties 825 then signals the information describing the set of subsamples in the pattern that corresponds to subsample descriptions referencing the pattern.

In some cases, the use of the PatternBox has the drawback of being less efficient than the solution proposed by the first embodiment. Indeed, the description of the PatternBox introduces additional costs compared to referencing a previous subsample as in the first embodiment. However, using the PatternBox is advantageous when the number of samples to which it applies is high. In both embodiments, the shared properties are stored once and only once in the media file and shared by reference by all the corresponding subsample descriptions.

In addition PatternBox enables random access by a reader to any samples as the referencing mechanism does not require the parsing of all the samples in sequence. This mechanism may be used for describing pattern applying to a single subsample, by similarity to the first embodiment, by setting the parameter pattern_length to the value 1, providing a random access capacity at the subsample level.

A first alternative for the PatternBox mechanism is to define a parameter pattern_length 830 that applies to all the patterns instead of the parameter pattern_length 820 that applies to a single pattern. Using this common parameter may be signaled by setting the value of fixed_nb_subsamples_per_sample to 1. This may be the case, for example, depending on the pattern granularity, when either the pattern applies at the sample level and all the samples have the same number of subsamples, or when the pattern applies at the subsample level and all the patterns contain the same number of subsamples.

Note that a pattern may be restricted to apply only to a full sample. It may also apply only to a set of subsamples inside a single sample. It may also apply only to one or more full samples. It may also apply to any sequence of sub-samples contained in one or more samples.

FIG. 6 illustrates a parsing method according to an embodiment of the invention. The media player 350 may use the de-encapsulation module 360 to parse the provided ISOBMFF file 335. The parsing process may use implicit references to a previous subsample, or explicit references to a pattern for the identification of the information corresponding to subsamples and may use this to refer to information for the correct reconstruction of a compliant bitstream or possibly to extract a subset of data corresponding to specific subsamples. Whether such references may be used is typically indicated through the version number of the ‘subs’ box; for instance, 0 or 1 indicate explicit encoding of the sub-sample information, while 2 or 3 indicates encoding that may use reference to previous subsamples. Version 2 or 3 may also make use of generic (in opposition to codec-specific) flags values. For example, in the case of the extraction of point cloud data, it may consist in keeping only the geometry data unit and a subset of attributes data units. For example, in the case of the extraction of video data, it may consist in keeping only NALU data unit corresponding to a specific set of sub-pictures.

The first step 600 comprises receiving the media file to be parsed. This media may be streamed from distant location using the communication network 330 or it may be read from a storage location.

The step 605 comprises initializing the de-encapsulation module 360. This is done by parsing the top-level boxes of the media file, for example the ‘moov’ box and its hierarchy of boxes, e.g., the ‘trak’ boxes and sample description boxes. When the media player contains a decoder module 370, the decoder may also be initialized during this step, for example using decoder configuration information from the sample description (e.g. the ‘G-PCC’ configuration box ‘gpcC’).

At step 610 a sample is read. The de-encapsulation module 360 reads the sample description from metadata part of the media file 335 to locate the corresponding data in a media data box.

At step 615, the de-encapsulation module 360 checks if the usage of ISOBMFF requires access to details of the subsample information. Indeed, some samples may have no subsample description. For example, when sample_delta information is set to a value>1, next subsample description is not for the following sample.

When the operation requires accessing subsample information, then step 620 reads the subsample description provided in the ISO Base Media file.

Then, in step 625, for each subsample composing the sample, a first check is done to verify if the subsample description refers to common properties. This is for example realized in either the first or the second embodiment by checking if the has_reference flag is set to 1 in the subsample description. As an example, in the first embodiment, if we assume that references are used to indicate similar values for subsample_priority, discardable and codec_specific_parameters, has_reference equal to 0 means that subsample_priority, discardable and codec_specific_parameters are explicitly indicated for considered sub-sample. With the same assumptions, has_reference equal to 1 means that the values of these properties are identical to the corresponding ones for the sub-sample indicated by reference_id, which is an integer that specifies the index of a sub-sample in a reference table. Each entry in said table may comprise a set of values for subsample_priority, discardable and codec_specific_parameters, a number of occurrences, and an appearance index. The reference table is typically initially empty. In addition, to preserve random access, the reference table is also typically reset on each sync sample.

In the case where there is no reference to another sub-sample or set of subsamples, the description is directly read, at step 630, from the subsample description using the set of parameters 710 or 845. In addition, when using reference to a previous subsample, as in the first embodiment, the current subsample description is stored in a SubsampleArray structure to be used if referenced from a later subsample. To provide more details on this case, and for illustrative purpose, let us consider that the reference table has a maximum number of entries equal to 128. When a subsample for which has_reference equals 0 is met, a new entry is created based on the values of subsample_priority, discardable and codec_specific_parameters, with a number of occurrences of 0, and an appearance index equal to the number of subsamples that have been previously processed. It is then checked whether the reference table comprises fewer than 128 entries. If so, the new entry is appended to the table. If not, the new entry replaces the entry of the table with lowest number of occurrences (1st criterion) and lowest appearance index (2nd criterion).

When a reference exists, then step 635 is realized to find the referenced description. This may comprise, in the case of a reference to a previous subsample, accessing the information stored in the SubsampleArray at the index indicated by reference_id. For instance, in this case, and if we assume the same context as the one described in previous paragraph for illustrative purpose, when a sub-sample for which has_reference equals 1 is met, the entry of the reference table with corresponding reference_id is updated by incrementing its number of occurrences by 1 and by setting its appearance index to the number of sub-samples previously processed. If the pattern_length parameter is also present, step 635 also comprises obtaining the common properties for the subsequent subsamples based on the values of the pattern length parameter and the reference_id parameter. For an explicit pattern description, the PatternBox with the same codec-specific part of the flags parameter is identified and the pattern (containing the common properties) referred to by the value of the pattern_id parameter is extracted. If the pattern_id parameter is indicated only for the first subsample corresponding to a pattern, then the description for all the subsamples corresponding to the pattern is obtained. Otherwise, if the pattern_id parameter is indicated for each subsample corresponding to a pattern, step 635 is limited to retrieving the description for the current sub-sample.

Then using the common properties and the remaining additional description of the subsample information box (typically the subsample_size), the data unit corresponding to the sub-sample is retrieved and provided to decoder at step 640. As described in reference to step 635, it may happen that the reference corresponds to several subsamples; in this case, step 640 is applied for all these subsamples. Then, step 645 performs a check to identify if more subsamples are present for the current sample. If yes, steps 620 to 645 are iterated.

If no further subsamples are present, an additional check 650 is realized by the media writer to check whether there is any further sample to process. If this is the case then the process continues at step 610. Otherwise, the parsing of the media file is finished. This step 650 is also realized after step 620 when the access to subsample(s) information is not required.

In addition to all the previously described embodiment, further optimizations of the subsample information box may be contemplated.

Further modifications of the syntax of the subsample information box may enable to reduce the cost of the subsample description. For that purpose, the different fields introduced in the generic part of the flags parameter may be used. These proposed modifications either reduce the size of the property description or remove information that may be deduced from other ISOBMFF boxes. The different fields may be used separately or simultaneously in any combination.

When the flag field applies_to_all_sample is set to 1 in the generic part of the flags parameter 715, it means that all the samples contain subsamples. It enables a first reduction of the subsample description by removing the parameters entry_count 720 and sample_delta 735. Indeed, when description applies to all samples of a track, the sample_delta value may be inferred to have the value 1 and the entry_count (720) is the number of samples, that is known by media player, for example by reading the entry_count information contained in the TimeToSampleBox (‘stts’) or SampleSizeBox (‘stsz’) boxes.

For example, the file writer 300 may set this field to 1 when the user requires an encoding applying the same subsample organization to all samples, through an encoder configuration. For offline encapsulation, the writer may analyse the media file in a two-pass manner so as to determine whether all samples have a subsample description or not. For some applications, the writer may determine it by configuration settings or by construction: for example, when encapsulating point cloud data as single track according to ISO/IEC 23090-18, it knows that all the G-PCC units will be described as sub-samples, for every samples.

In an alternative, the number of consecutive samples that are described in the ‘subs’ box may be signalled by a new sample_count parameter, for example using the following syntax:

```
  aligned(8) class SubsampleInformationBox
  extends FullBox(‘subs’, version=2 or 3, flags) {
  unsigned int(32) entry_count;
  for (int i=0; i < entry_count; i++) {
      unsigned int(32) sample_delta;
        unsigned int(32) sample_count;
        for (int k=0; k < sample_count; k++) {
          unsigned int(16) subsample_count;
          if (subsample_count > 0) {
            for (int j=0; j < subsample_count; j++) {
              if (version==3)
              {
                unsigned int(32) subsample_size;
              }
              else
              {
                unsigned int(16) subsample_size;
              }
              unsigned int(1) has_reference;
              if (has_reference == 1)
                unsigned int(7) reference_id;
              }
              else {
                unsigned int(7) reserved;
                unsigned int(8) subsample_priority;
                unsigned int(8) discardable;
                unsigned int(32)
codec_specific_parameters;
              }
            }
          }
        }
    }
  }
```

Possibly, in the loop over the entry_count value, the variable i is increased by the value of the sample_count parameter.

When the flag field regular_sample_pattern is set to 1 in flags 715, it means that the samples containing subsamples are regularly spaced inside the media and therefore the sample_delta parameter value is the same for all the entries of the ‘subs’ box. It enables reducing the subsample description by defining the sample_delta value 730 only once in the subsample information box and removing its definition 735 at the entry level. Using this modification avoids the repetition of the sample_delta parameters for all entries of the ‘subs’ box.

For example, this field may be set to 1 by file writer 300 when all the samples contain only one subsample except one in fifty samples that can be used as random access points and that contain a first subsample containing some encoding parameters and a second subsample containing the actual encoded media frame.

Note that when using this regular_sample_pattern field, an initial sample_delta parameter may also be encoded to indicate the value of the sample_delta for the first entry contained in the ‘subs’ box.

When the flag field fixed_nb_subsamples_per_sample is set to 1 in flags 715, it means that all the samples are organized with the same number of subsamples. It enables reducing the subsample description by defining subsample_count 740 at the higher level for all the samples, and by removing its definition 745 at the entry level. Using this modification, it avoids the repetition of the subsample_count parameter for each entry in the ‘subs’ box.

For example, this field may be set to 1 by file writer 300 when a point cloud bitstream is encapsulated in a single track data where VolumetricVisualSampleEntry is defined with a sample entry type ‘gpc1’: each sample contains one subsample corresponding to a geometry data unit and one or more subsamples corresponding to attribute data units.

As a variant, the subsample_count parameter may be replaced by an array of subsample_count values, enabling to describe the number of subsamples for each sample when this number is not constant for all the samples but follows a regular pattern.

When the flag field merged property is set to 1 in flags 715, it means that an optimized syntax is used for the coding of the description of a sub-sample. It enables reducing the subsample description by using a more compact description. In this case the set of property 710 is replaced by a unique sub_sample_property parameter 750. This parameter may store only the value of the codec_specific_parameters parameter.

For example, for some standards like SVC, the codec_specific_parameters parameter already includes a DiscardableFlag parameter and PriorityId parameter. Therefore the merged_property parameter may be set to 1 by the file writer when encapsulating this type of bitstream, avoiding the repetition of information or presence of parameters that are not always specified for ISOBMFF-derived specifications (for example the discardable or subsample_priority parameters). In this case, the sub_sample_property parameter is used to store the value of the codec_specific_parameters parameter.

It is to be noted that the new versions of subs box described in previous embodiments may be described as a new box, still for subsample description, but in a more compact way. This box may then have a different 4CC than the ‘subs’ box, for example ‘csbs’ for Compact Subsample information box. This box may contain the various embodiments encoding subsample information by reference. It may also contain the new usage of flags values with a generic part and a codec-specific part. It may be stored in track or track fragments. Several occurrences of this box may be present in a same container box provided that their codec-specific flags value differ. Having the compact subsample description in a dedicated box may make life easier for writers or parsers, avoiding the versioning handling plus the combination with the new usage of the flags value (containing a generic part or not). The same distinction may apply for sub sample properties for a collection or a sequence of media items. A brand may indicate when this new box is in use, so that parser can determine whether they can process the subsample information or not.

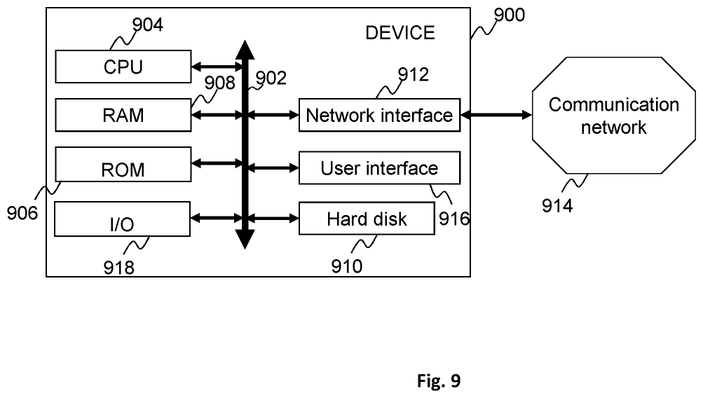

FIG. 9 is a schematic block diagram of a computing device 900 for the implementation of one or more embodiments of the invention. The computing device 900 may be a device such as a microcomputer, a workstation, or a light portable device. The computing device 900 comprises a communication bus 902 connected to:
a central processing unit (CPU) 904, such as a microprocessor;
a random access memory (RAM) 908 for storing the executable code of the method of embodiments of the invention as well as the registers adapted to record variables and parameters necessary for implementing the method for encapsulating, indexing, de-encapsulating, and/or accessing data, the memory capacity thereof can be expanded by an optional RAM connected to an expansion port, for example;
a read-only memory (ROM) 906 for storing computer programs for implementing embodiments of the invention;
a network interface 912 that is, in turn, typically connected to a communication network 914 over which digital data to be processed are transmitted or received. The network interface 912 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 904;
a user interface (UI) 916 for receiving inputs from a user or to display information to a user;
a hard disk (HD) 910; and/or
an I/O module 918 for receiving/sending data from/to external devices such as a video source or display.

The executable code may be stored either in read-only memory 906, on the hard disk 910 or on a removable digital medium for example such as a disk. According to a variant, the executable code of the programs can be received by means of a communication network, via the network interface 912, in order to be stored in one of the storage means of the communication device 900, such as the hard disk 910, before being executed.

The central processing unit 904 is adapted to control and direct the execution of the instructions or portions of software code of the program or programs according to embodiments of the invention, which instructions are stored in one of the aforementioned storage means. After powering on, the CPU 904 is capable of executing instructions from main RAM memory 908 relating to a software application after those instructions have been loaded from the program ROM 906 or the hard-disc (HD) 910 for example. Such a software application, when executed by the CPU 904, causes the steps of the flowcharts shown in the previous figures to be performed.

In this embodiment, the apparatus is a programmable apparatus which uses software to implement the invention. However, alternatively, the present invention may be implemented in hardware (for example, in the form of an Application Specific Integrated Circuit or ASIC).

Although the present invention has been described herein above with reference to specific embodiments, the present invention is not limited to the specific embodiments, and modifications will be apparent to a person skilled in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

FIG. 10 is another example of metadata structures providing subsample description. In the contrary to previous embodiments, this embodiment is not based on a subsample information box.

The subsamples are illustrated by reference 1010 that may correspond to a media data box ‘mdat’ or ‘idat’ or ‘imda’ of the media file. 1010 is a data container for bytes of data (ex: video data, audio data, text data or volumetric data . . . ). Each sample may have subsamples or not. For example, sample A has 3 subsamples. For example, sample E (1011) has no subsample. As another example, sample X (1012) has only a subsample description for its second part 1012-2.

Some samples may have the same number of subsamples (like samples A and Z, which have 3 subsamples, or samples M and N, which have 2 subsamples). Some subsamples in different samples may also share the same properties. For example, samples A and Z may have their first subsample that is a geometry data unit. As another example, the subsamples for samples N and M may correspond to sub-pictures or tiles or slices having the same position inside the images of an image sequence.

Most of the time, especially for compressed data, the size of the subsamples may vary within each sample.

In this embodiment, the metadata structures providing subsample description are generated by a file format writer during an encapsulation step. These metadata structures, when present in a media file, are used by file readers (or parsers) to get information on subsamples, for example for partial access or partial extraction or partial decoding.

According to the embodiment illustrated on FIG. 10, there may be four metadata structures to describe the subsamples.

The box 1020 is a metadata structure grouping samples having the same sub-samples patterns. It may be implemented in ISOBMFF or specifications deriving from ISOBMFF as a SampleToGroupBox ‘sbgp’. For example, samples A and Z may be mapped to the same entry in the Mapping Table 1030, for example using the group_description_index parameter of the SampleToGroupBox. This usage means that group_description_index=1 links samples having this group_description_index value to the first entry in the mapping table 1030 (subsample pattern 1031 in the example of FIG. 10). A specific grouping type may be used to indicate that the purpose of sample grouping is for subsample description. The specific grouping_type value may be a 4CC value like ‘subs’ or ‘ssso’ for samples' sub-samples offsets. The grouping_type_parameter of the ‘sbgp’ may be used to indicate the type of the subsamples: picture, frame, subframe, sub-picture, slice, tile, coding tree unit, TLV unit . . . . A dedicated 4CC may be defined for each subsample type: for example, ‘tlvu’ for TLV unit, ‘sIce’ for slice, ‘tile’ for tile, etc. . . . so that a writer and a reader can understand unambiguously the kinds of subsamples that are described in the media file. The entry_count and sample_count parameters keep the same semantics as defined in ISOBMFF. The samples that have no subsample or no subsample description, like sample E, may use a group_description_index with value 0 to indicate that they are not mapped to any subsample pattern.

The box 1030 is a metadata structure defining a list of subsample patterns. A subsample pattern contains a number of subsamples with a list of their associated subsample properties. For example, subsample pattern 1031 consists in 3 subsamples: the first being associated with the first property of a property container, the second being associated with the second property of this same property container, the third being associated with the third property of this same property container. A subsample pattern may contain an identifier. When no identifier is present, a subsample pattern may be referenced via an implicit index corresponding to its declaration order in the metadata structure 1030. For example, the first entry in the Mapping Table 1030 is the subsample pattern 1031, the second subsample pattern is 1032, etc. The Mapping Table 1030 may be implemented in ISOBMFF as a SampleGroupDescriptionBox ‘sgpd’. The grouping_type value of this ‘sgpd’ may be used to indicate that the description is about subsample information. For this purpose it may be set to the same value as the one used in the sbgp implementing the metadata structure grouping samples having the same subsample patterns 1020, for example: ‘subs’ or ‘ssso’. The ‘sgpd’ for subsample patterns may contain a number of patterns, for example indicated by the entry_count parameter. In the example 1030, the number of patterns is 3. Then, each subsample pattern may be defined as a specific SampleGroupEntry, as follows:

```
abstract class SubsampleSampleGroupEntry (unsigned int(32)
grouping_type) extends SampleGroupDescriptionEntry
  (grouping_type)
  {
    unsigned int (16) nb_subsamples;
    unsigned int (16) property_index [nb_subsamples];
  }
```

where:
nb_subsamples parameter indicates the number of subsamples within a pattern (3 for 1031, 2 for 1032 and 2 for 1033).
property index indicates for each sub-sample of a pattern a reference to a property or to a list of properties associated with this subsample (“(1)” for 1st subsample of the subsample pattern 1031, “(6)” for the 2nd subsample of the last subsample of the subsample pattern 1033 declared inside 1030). The reference to a property or to a list of properties may corresponds to an entry in a property container 1040. A subsample may not be associated with any property like the first sub-sample of subsample pattern 1033.

The box 1040 is a metadata structure defining properties or list of properties that may be associated to subsamples. Elementary properties may be defined like P1, P2 . . . . P5 or list of properties may also be defined like the 5th entry “Plist” 1045 consisting in two properties P1 and P4. This means that when a sub-sample is associated with this 5^{th} entry (like for example the 1^{st} subsample of the subsample pattern 1032), the corresponding subsample has these 2 properties. A list of properties may be defined suing references to already defined properties in the property container 1040. For example, the entry (5) in 1040 may be defined by referencing (1) and (4). A list of properties may then consist in a number of properties followed by a list of references. The size of the list corresponds to the number of properties.

In a first variant, the metadata structure defining properties or list of properties 1040 may be implemented in ISOBMFF or derived specifications as a new Box or FullBox dedicated to the declaration of subsample properties. This box is identified by a 4CC, for example ‘sspo’ for subsample properties. Each property may be declared as a 32-bit parameter. Optionally, in a specific version of the box, or depending on the flags value of the box, the 32 bits code may contain one bit (for example the most significant bit) dedicated to indicating an extension: when set to 1, this bit indicates that an additional 32 bits code follows for further describing the property. When set to 0, this bit indicates that there is no additional 32 bits code to describe the property. As an example, codec_specific_parameter value of the subsample information box of the previous embodiments may be stored as a property inside this new box. Another example may also be a combination of the codec_specific_parameter with the subsample_priority and the discardable parameters of the subsample information box. The former may not require the use of the extension bit while the latter does.

In a second variant, the metadata structure defining properties or list of properties may use an existing container, for example the ItemPropertiesBox containing an ‘ipco’ and an ‘ipma’ box. Each property may then be described as a specific box or full box inheriting from ItemProperty or from ItemFullProperty boxes in the ‘ipco’. In this variant, the association between a subsample and its properties may be described in the ‘ipma’ where the item_ID corresponds to an identifier of a sub-sample in the metadata structure defining a list of subsample patterns 1030. In this variant, the metadata structure defining a list of subsample patterns 1030 then consists in a list of subsample patterns that may only indicate a number of subsamples for the samples mapped to one entry of this box 1030. The reference to a property or to a list of properties may not be present. As well, the SubsampleSampleGroupEntry may only contain a number of subsamples and no property indexes. The ItemPropertiesBox may be declared in a ‘meta’ box of the track containing the samples with subsamples, for example.

The box 1050 is a metadata structure defining a list of byte ranges. It may contain byte ranges only for samples that are mapped to a subsample pattern in 1020. By default, each byte range is encoded on 32 bits. In some variants, where an indication of a maximum length for the data units is available, the byte ranges may be coded on fewer bytes (e.g. 8 or 16). This maximum length, for example, may be determined from the DecoderConfigurationRecord in some sample entries (e.g. the lengthSizeMinusOne in ‘avcC’, ‘hvcC’ or ‘vvcc’). Samples that are not mapped to any subsample pattern (liked sample E) may not have their sample size or any byte range indicated in the metadata structure defining a list of byte ranges 1050. Samples containing subsamples that are associated with subsample properties and subsamples not associated to any subsample property (e.g. sample X) may have all their byte ranges (1053) given in the metadata structure defining a list of byte ranges 1050. The metadata structure 1050 may be implemented in ISOBMFF or in a derived specification as a new version of the subs box:

```
aligned(8) class SubsampleInformationBox
    extends FullBox(‘subs’, version, flags) {
    if (version=new_version) {
      unsigned int(32) entry_count;
        unsigned int(num_bytes) subsample_size [entry_count];
  } else { // original ‘subs’ box
    unsigned int(32) entry_count;
    int i,j;
    for (i=0; i < entry_count; i++) {
        unsigned int(32) sample_delta;
        unsigned int(16) subsample_count;
        if (subsample_count > 0) {
          for (j=0; j < subsample_count; j++) {
            if(version == 1)
            {
              unsigned int(32) subsample_size;
            }
            else
            {
              unsigned int(16) subsample_size;
            }
            unsigned int(8) subsample_priority;
            unsigned int(8) discardable;
            unsigned int(32) codec_specific_parameters;
          }
        }
    }
}
```

where:
entry_count indicates the number of byte ranges (sub-sample sizes) declared in the box;
subsample_size indicates the number of bytes for a subsample;
num_bytes indicates the number of bytes used to encode the subsample_size. This number of bytes may be 32 bytes by default or may depend on information about the sample description as explained above.

This embodiment has the benefit of mutualizing the properties, which are declared once and referenced in multiple subsample patterns. It avoids indicating the number of subsamples for each sample having a subsample description as is the case in the subsample information box.

It is to be noted that the properties defined in metadata structure 1040 could also be defined within each subsample pattern in metadata structure 1030. However, this would be a bit less efficient than the current approach illustrated by FIG. 10 because it provides less mutualization. For example, with such a variant, the property P1 would be declared two times in mapping table 1030: one time for the first subsample pattern 1031, one other time for the second subsample pattern 1032.

FIG. 11 illustrates the main steps of a method for encapsulating subsample description using the data structure illustrated by FIG. 10.

In 1100, the encapsulation is setup: this comprises obtaining the type of data to encapsulate, the number of tracks, the formats in use, etc that will be used to create the ‘moov’ box, and its sub-boxes for ISOBMFF and derived specifications. The encapsulation may generate one media file, fragmented or not or many media segment files, this choice being part of the setup step 1100. The encapsulation module may create the metadata structures like those illustrated in FIG. 10.

In step 1101, the encapsulation module reads first data to encapsulate. The data may be compressed data, for example compressed audio or video or may be uncompressed data like text or even raw audio or video. The first data read in 1101 may correspond to information on the type of data (e.g. video or audio or text or volumetric data . . . ). For compressed data, the first data may provide information on the codec(s) in use (e.g. AVC, HEVC, VVC for video or some point cloud compression codec). The data may be read as soon as it is generated, captured, or encoded, or may be read from a storage medium.

In step 1102, the encapsulation module determines the type of subsamples for the media to encapsulate. When the data contains several media types, this may be done for each media type. When one media type is encapsulated into multiple tracks, the determination of subsample types may be made for each track or for a subset of tracks, otherwise it may be determined when reading a sample. When determined, the subsample type may be indicated in the grouping_type_parameter of the sample to group box ‘sbgp’ or, more generally, in a dedicated parameter used for indicating the subsample type in the metadata structure 1020.

In step 1103, the encapsulation module reads sample data. The sample data may be composed of data units matching subsample description (for example NAL units in NAL unit-based video codecs or TLV units for G-PCC bitstreams). Using sample data read in 1103, the encapsulation module may determine the number of subsamples with their size in bytes, respectively in steps 1104 and 1105. Then, by parsing information either in the initial data or in the sample data, the encapsulation module determines in step 1106 the properties for some or all the subsamples of the current sample. For example, for G-PCC input data, parsing a TLV type may provide the property for a G-PCC unit-based sub-sample. As another example, parsing the NAL unit type allows determination of the vcl_idc parameter for an HEVC slice subsample or a VVC sub-picture subsample.

In step 1107, the encapsulation module checks whether the metadata structure storing the subsample patterns (1030) already contains a pattern with the same number of subsamples and the same associated property or list of properties. If it is the case, the current sample is mapped in the metadata structure 1020 to the found entry in the metadata structure 1030 in step 1108. If the test 1107 returns false, a new entry is created in the metadata structure 1030 with the determined number of samples and their associated properties or list of properties in 1109. If the properties are stored within a subsample pattern in the metadata structure 1030, the encapsulation module may generate the property values or list of property values within the subsample pattern in the 1030 metadata structure. If the properties are stored in their own metadata structure 1040 (the storage location of the properties may be a setting of the encapsulation in 1100), the encapsulation module may add any missing property or property list in the metadata structure 1040 and insert a reference to the property or the property list corresponding to each sub-sample in the metadata structure 1030. This process is repeated until no more samples are available for reading in 1110. Then, when no more samples remain to be read, the encapsulation module finalizes the media file or segment file in 1111. This may comprise, for example, finalizing boxes providing indexing information for a media file or for a media segment file or in computing additional sample description parameters to insert in the sample description.

The parsing of a media file or media segment file encapsulated according to this embodiment may follow the same process described in relation with FIG. 6. For the initialization and the loop on data reading, the way a reader obtains subsample information is a bit different when the metadata structures described in reference to FIG. 10 are in use, in particular in steps 620 to 645. These differences are now described.

Each time a sample is read in 610, the parser locates the corresponding sample in the metadata structure grouping samples having the same subsample patterns 1020. This is done by keeping in memory the number of the read samples in the sequence of samples. The metadata structure 1020 follows the same sample order as the sample description in ‘stbl’ and its sub-boxes (or in ‘trun’ for fragmented files). The parser then obtains the group_description_index for this sample and use it to locate a subsample pattern corresponding to the current sample. In parallel to reading the sample and obtaining the group_description_index, the parser also iterates over the metadata structure defining a list of byte ranges 1050. For example, from FIG. 10 when the sample A is read, its corresponding subsample pattern obtained from 1020 is also read in 1030 and the byte ranges for the 3 subsamples of the sample A are read from 1050. By doing so, the parser then gets for a sample its subsamples with their byte ranges. To obtain the properties, the parser simply reads from the subsample pattern in 1030 the properties or list of properties, either directly for the variant including the properties inside the subsample patterns or by reference to a property container in the variant using references in the subsample pattern. When references are used, the parser then search the property container 1040 to obtain the property values applying to a sub-sample of the current sample. For the specific case of sample E that is not mapped, the parser may not read anything in the metadata structure defining a list of byte ranges 1050 for a variant not including byte range of non-mapped samples. This process is iterated over the samples of a movie fragment (fragment file) or of a whole sequence (non-fragmented file). In case the reader performs seek or randomly accesses the media file, the parser may loop over the metadata structure grouping samples having the same subsample patterns 1020 to identify which entry in the Mapping Table 1030 the current sample is mapped to. As well, it may obtain the number of subsamples for the preceding samples to synchronize the reading in the metadata structure defining the list of byte ranges. To avoid this, in a variant, the metadata structure defining a list of byte ranges 1050 may contain delimiter between samples, for example a 32-bit code equal to 0xFFFFFFFF. So that by detecting these separators, a parser can synchronize on the first byte range for the current sample, thus avoiding the need to determine the cumulated number of byte ranges between the first sample and the current sample parsed or randomly accessed by the parser.

In an alternative embodiment, a dedicated box comprises a set of entries, each entry comprising subsample properties. For example, each entry may comprise a tuple of the form (subsample_priority, discardable, codec_specific_parameters). Then, when providing the description of a sub-sample in the ‘subs’ box, references to said entries may be used.

Compared to previous embodiments, this embodiment is less complex. In particular there is no need to handle a dynamic table as the set of entries in the dedicated box constitutes a static table of subsample's properties. The fact that this table is static offers more flexibility to writer/reader. Support of random access is also much easier with a static table.

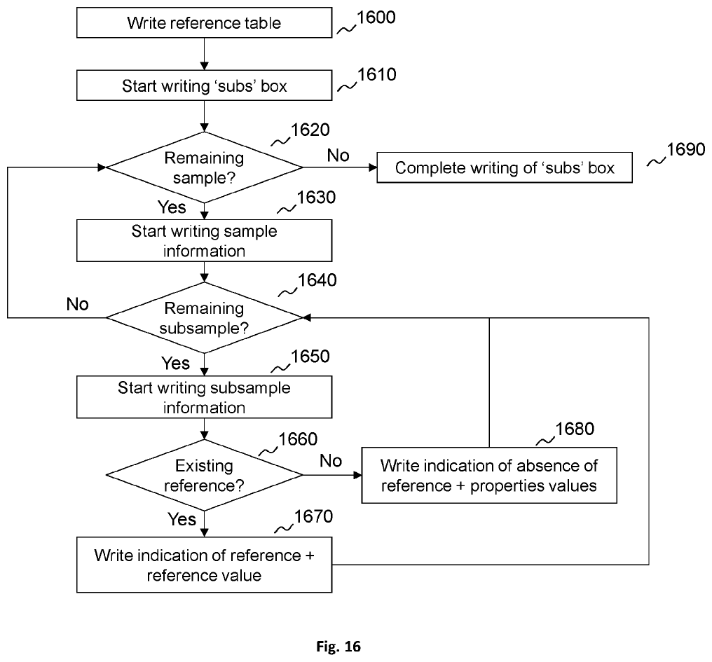

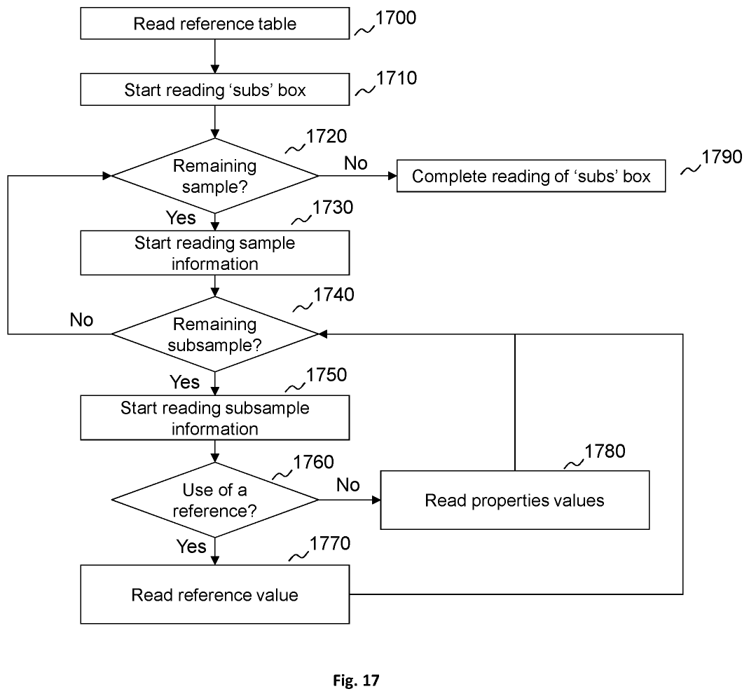

An example of this embodiment is provided in FIGS. 16 (writer side) and 17 (reader side). FIGS. 16 and 17 do not focus on the whole writing/reading of an ISOBMFF file, but only on the writing/reading of the reference table and subsamples description.

FIG. 16 illustrates the main steps of a method for writing the reference table and the subsamples description in an embodiment of the invention. At step 1600, writer starts by writing or initiating a reference table to be encapsulated in an ISOBMFF box that is adapted to describe a reference table (for instance a Sub-sample Reference Table Box ‘ssrt’ as described hereafter). To do so, writer first determines a list of subsamples for which some of the subsample properties (e.g. (subsample_priority, discardable, codec specific_parameters) tuple) are redundant, or likely to be redundant. In other words, each of these tuples applies (or is likely to apply) to more than one subsample. This can for instance be done by checking all such tuples for the data to be encapsulated. Alternatively, one skilled in the art may be aware that in some specific cases (e.g. for a given type of subsample), such tuples are likely to be redundant, in which case a writer may be configured so that it adds all such tuples to a reference table. As another alternative, it may happen that for a given type of subsample or in a given situation, the possible values of such tuples are known in advance, in which case a writer may be configured with corresponding tuples in its reference table.

After that or in parallel, writer starts writing a ‘subs’ box at step 1610 (e.g. to indicate the version number of ‘subs’ box or the number of samples to be described). It is then checked at step 1620 whether there remains a sample to describe. If so, at step 1630, writer starts writing sample description (e.g. sample_delta, subsample_count). Then, at step 1640, it is checked whether there remains a subsample to be described in the current sample. If so, writer starts writing subsample properties that may not be described through a reference to the reference table (step 1650), e.g. typically properties describing the location, size or byte range of the subsample in the sample (e.g. subsample_size). For instance, assuming that the property subsample_size is not included in the tuples of the reference table, the subsample_size associated with the subsample is indicated in the ‘subs’ box at step 1650. At step 1660, it is then checked whether an entry of the reference table matches the corresponding properties for considered subsample (e.g. if reference table comprises (subsample_priority, discardable, codec_specific_parameters) tuples, it is checked whether the values of subsample_priority, discardable and codec_specific_parameters are identical between currently considered subsample and an entry of the reference table). If so, said properties can be described through a reference to the reference table. Therefore, at step 1670, an indication that a reference is used in written, as well as corresponding reference value (which may typically be the index of the corresponding entry in the reference table). On the other hand, if no such entry is found at step 1660, values of corresponding properties are written explicitly in the ‘subs’ box.

Steps 1670 and 1680 are followed by step 1640. When there does not remain an unprocessed subsample at step 1640, step 1640 is followed by step 1620. When there does not remain an unprocessed sample at step 1620, step 1620 is followed by step 1690 where writer completes the writing of the ‘subs’ box and the ‘ssrt’ box.

FIG. 17 illustrates the main steps of a method for reading the reference table and the subsample description in an embodiment of the invention. This process is very similar to the process described in FIG. 16, except that it is on the reader side. Therefore, some of the details provided with regards to FIG. 16 are not provided here, but they apply similarly.

First, at step 1700, the reference table is read (e.g. an ‘ssrt’ box as described hereafter). Contrary to the writer side, the reader is not responsible for selecting some tuples to be added to the reference table. Instead, it just reads this table. Alternatively, the reader may read the box describing the reference table the first time he needs to determine the values of the properties corresponding to a reference used in the ‘subs’ box.

Then, at step 1710, reader starts the reading of a ‘subs’ box. At step 1720, it checks whether there remains a sample to be read. If so, it starts reading sample information at step 1730 (e.g. sample_delta, subsample_count). It is then checked whether there remains a subsample to read (step 1740). If so, reader starts the reading of subsample information. This typically includes the reading of properties that are not present in the tuples of the reference table (for instance, subsample_size may be read at this step). Then, at step 1760, it is checked whether a reference is used to describe other properties e.g. by checking if the has_reference flag is true. If so, corresponding reference value is read at step 1770 (e.g. the index of corresponding tuple in the reference table). If no, explicit values of properties are read at step 1780.

Steps 1770 and 1780 are followed by step 1740. At step 1740, if there is no remaining subsample, the next step is step 1720. If there is no remaining sample at step 1720, step 1720 is followed by step 1790, where the reader completes the reading of the ‘subs’ box.

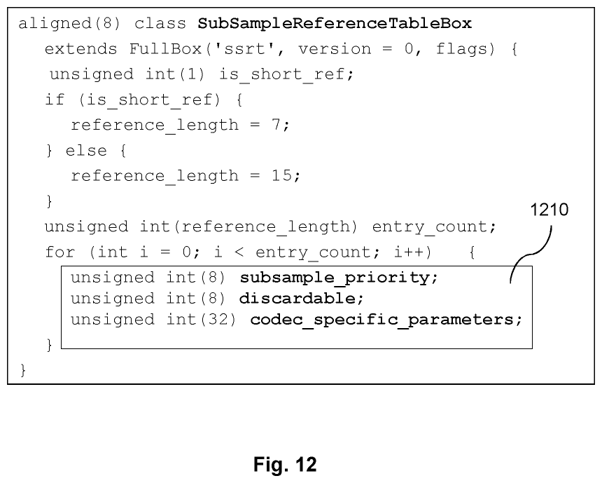

FIG. 12 illustrates an example definition of a box for describing tuples of properties that may be referenced to in the description of a sub-sample. This box is designed to contain a list of properties of sub-samples that are likely to occur several times. In this example, the box is named SubSampleReferenceTableBox, and its short name (4CC) is ‘ssrt’ or any other value of 4CC not yet assigned by an existing specification. More generally, in the following of this document, this table may be called a reference table.

First, a 1-bit value is_short_ref is used to indicate whether short references are used or not. E.g., is_short_ref equals 1 indicates that there are at most 128 entries comprised in SubSampleReferenceTableBox, in which case 7 bits are used to encode the index of an entry in said table. When is_short_ref equals 0, at most 32.768 entries are comprised in the reference table, in which case 15 bits are used to encode the index of an entry in said table. The reason for using 7 or 15 bits is that ISOBMFF requires boxes to be byte-aligned: since 1 bit is typically used to indicate in ‘subs’ box whether a reference is used or not, the number of bits used for references is preferably a multiple of 8 minus 1. The drawback of using 7 bits is that only 128 entries may be present in the table, which may be too few in some cases. On the other hand, the drawback of using 15 bits is that it requires 1 more byte, which limits the gains that can be obtained through references. More generally, references of various lengths may be used, not necessarily 7 or 15 bits.

Next, the number of entries described in considered box is indicated through the entry_count variable. This variable is typically encoded on the same number of bits as the reference length: by doing so, entry_count is a value comprised between 0 and 2^{reference_length}−1 (alternatively, entry_count may be a value comprised between 1 and 2^{reference_length} since there is no benefit to defining an empty table of entries). Alternatively, the entry_count may be encoded using a fixed predetermined number of bits (e.g. 16-bits, 32-bits).

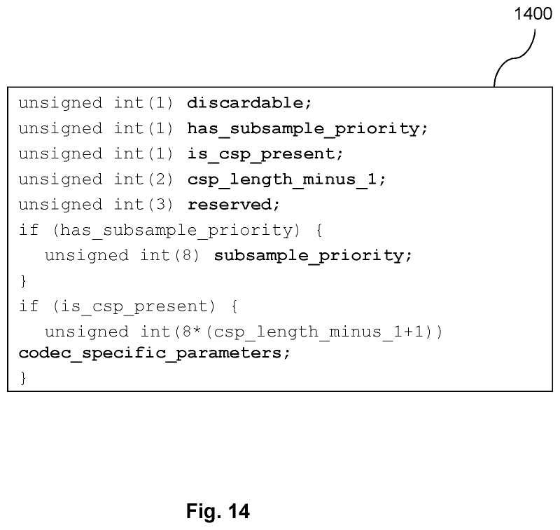

Then, a for loop is used to describe entry_count entries. As previously mentioned, each entry typically comprises a value for subsample properties (e.g. subsample_priority, discardable and codec_specific_parameters or a subset of these). In the example of FIG. 12, these values are stored as integers, respectively on 8, 16 and 32 bits. This is similar to how these values are represented in ‘subs’ box with versions 0 or 1 (block 1210). Alternatively, as described below in relation with FIG. 14, a different representation 1400 may be used.

While the simplest solution consists in having a single reference table (e.g. in a single ‘ssrt’ box) to which all references are made, there may also be cases where using multiple tables (i.e. multiple ‘ssrt’ boxes) could be advantageous. There may be different reasons for using more than one reference table: for instance, it may be more efficient to consider two reference tables with 7-bit references than a single reference table with 15-bit references. As another example, different parts of a file may use different properties values for sub-samples, in which case it may be more efficient to consider different tables. As another example, when different types of subsamples are described, there may be different reference tables, for example one per subsample type. In all these cases, there is a need to determine, for a given reference in a given ‘subs’ box, which reference table (and ‘ssrt’ box) it refers to.

The determination of the reference table may be based on the type of the SubSampleInformationBox ‘subs’. Some specifications define different types of sub-samples (for example through the flags field of the ‘subs’ box), each type being a different way of characterizing a sub-sample (e.g. characterizing a sub-sample as a subpicture, a slice or as a NALU or as a G-PCC unit). For each type, a specific value of ‘subs’ box's flags is defined, as for example in specifications deriving from ISOBMFF. In this case, we can advantageously specify that the reference table to which a reference refers is the reference table described by the ‘ssrt’ box whose flags value is equal to the one of considered ‘subs’ box own flags value. This preserves the original design of the ‘subs’ box authorizing multiple instances of ‘subs’ box in a media file provided that the value of their flags differ in each of these SubSampleInformationBoxes.

The determination of the reference table may be based on the location of the dedicated box describing the reference table in the hierarchy of boxes in the metadata part of the file. As an example, if there are multiple movie fragments or track fragments, each described in a ‘moof’ and ‘traf’ box respectively, it may be decided to use one reference table per movie fragment or per track fragment, in which case each reference table is advantageously located in the corresponding ‘moof’ or ‘traf’ box, the scope of each reference table being this ‘moof’ or ‘traf’ box. Optionally, it may also be decided to use a shared, global reference table that is common to all fragments or to all tracks when the file is not fragmented. This reference table may be located in the ‘moov’ box.

In an embodiment, a group of entities, typically tracks, is defined. This group of entities groups together the entities that refer to a same reference table in the description of their subsamples. In this case, an entity to group box may be defined to describe the group of entities. A group of entities is also generally designated as an “entity group” in ISOBMFF. Therefore, in the following, “entity group” refers to a group of entities that can be represented through an EntityToGroupBox (or entity to group box). The entity to group box further comprises the description of the reference table referred to by the entities.

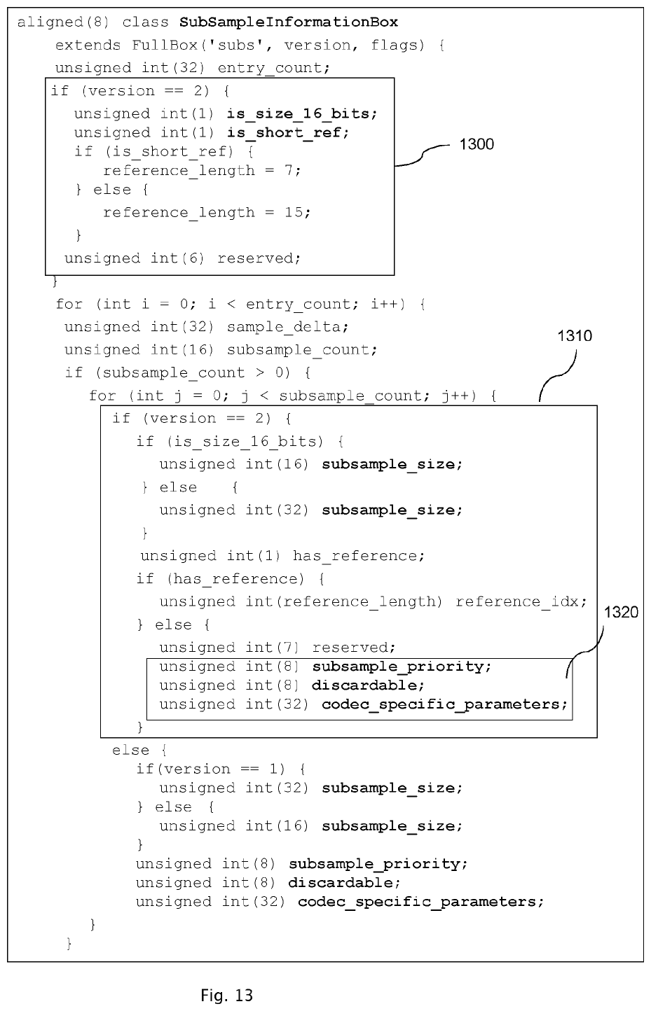

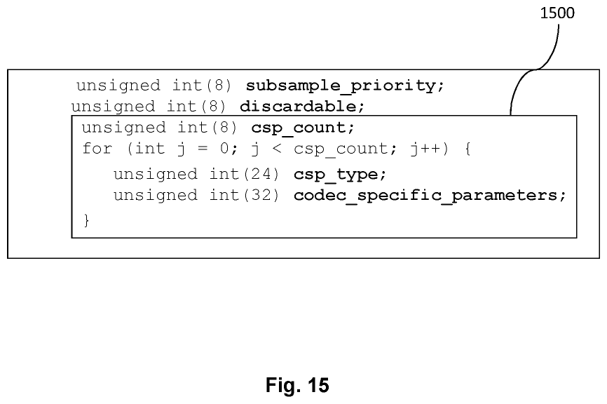

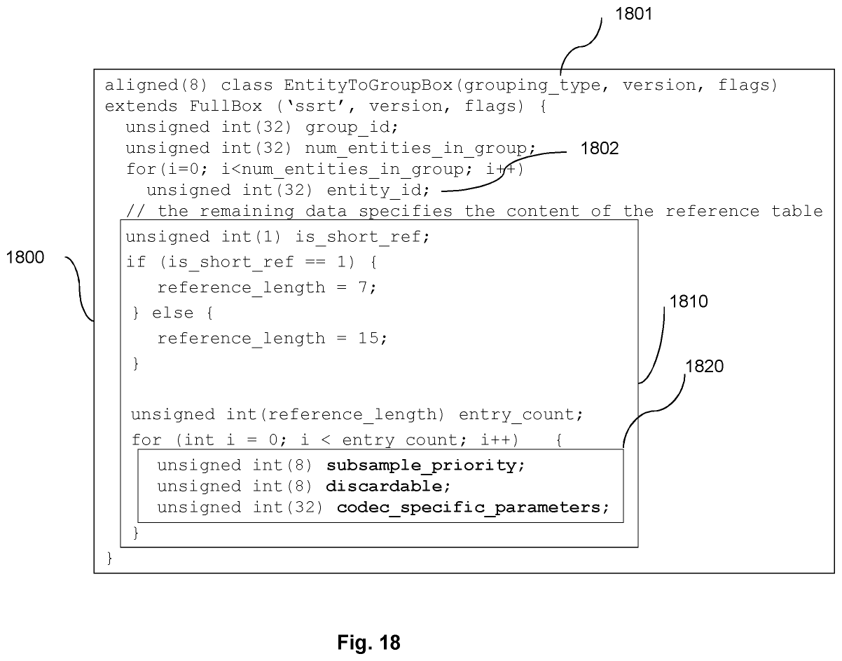

FIG. 18 illustrates an example of syntax of an entity to group that may be used to describe a reference table and the entities referring and that reference table in an embodiment of the invention. For example, an entity group with a specific grouping_type is dedicated to the storage of information described in the reference table. The grouping_type is a four-character code dedicated to common subsample properties, to be referenced from a ‘subs’ box with new version like on FIG. 13, for example ‘ssrt’ for sub-sample reference table. The entity_ids 1802 of this entity group indicate the tracks (through their track_ID) referencing entries of this reference table in their ‘subs’ box, when present. The reference table information corresponds to the block 1810. A subsample property may be defined by the set of parameters in the block 1820 or by its variants 1400 or 1500, as on FIG. 14 or 15, respectively.

There may be several instances of this entity group 1800 for sub-sample properties in a file. When each instance 1800 corresponds to a specific subsample type, an additional parameter may be defined in this entity group 1800 to indicate this sub-sample type. A same track may then be referenced in different groups of entities for sub-sample properties if it has different subsample types to describe. Alternatively, the grouping_type 1801 may indicate this subsample type, in addition to the type of the entity group (dedicated to subsample properties). Yet as another alternative, the flags of this entity group can be used to pair ‘subs’ boxes of the referenced tracks in the entity_id 1802 with the entity group of the corresponding subsample type.

In such a situation where there are both a global reference table and local reference tables (e.g. respectively in ‘moov’ and ‘moof’ boxes), there is a need to determine whether each reference in the ‘subs’ box refers to the global reference table or to a local reference table. For instance, this can be done by introducing a 1-bit integer is reference global in the new version of the ‘subs’ box, which indicates whether the reference is global or local. In a variant, instead of using an additional 1-bit integer, the maximum number of entries in each reference table might be divided by 2, in which case the most significant bit of a reference index can be used to indicate whether said reference index points to a global reference table (e.g. when most significant bit is equal to 0) or to the local reference table (e.g. most significant bit equal to 1). For instance, in this case, if 7-bit references are used, a reference index between 0 and 63 indicates a global reference, while a reference index between 64 and 127 indicates a local reference. Such variant may especially be applicable when a local table is located in a fragment, e.g. in a TrackFragmentBox. Preferably, a reference table is stored where a ‘subs’ is stored, e.g. in a SampleTableBox or in TrackFragmentBoxes, and the scope of the reference table is the track containing the SampleTableBox or the track fragment.

Please note that these comments are not specific to ‘moof’ and ‘moov’. The same ideas may be applied to multi-track data when multiple tracks (i.e. multiple ‘trak’ boxes) are described within a given ‘moov’ box.

It may also be noted that determination through location may also be combined with determination through type. In this case, if M different types of ‘subs’ are considered, there could for instance be M global tables with distinct types, and M*N local tables where N is the number of movie fragments (or tracks or track fragments).

Another option may consist in introducing, in any box that uses references to a table of entries, an explicit identifier of said table. This identifier may typically be indicated in the box describing the table (e.g. as an integer or a string). Such means may in particular be used if there is a need to distinguish several tables in the same container box and with the same flags value.

As an example, a field table_id coded as an unsigned integer on 8 bits may be added to the reference table in order to explicitly indicate the table identifier. Similarly, a reference_table_id (also encoded as an 8-bit unsigned integer) could be added to the ‘subs’ box, for instance in the block 1300 of FIG. 13. Advantageously, this field would be specific to versions of the box syntax that support the usage of references.

The length of references, meaning the number of bits used to represent a reference, is not necessarily indicated in the box describing the reference table. For instance, it might be decided that a reference table always comprises 128 entries. In which case, there is no need to indicate the length of references. In such cases, the example of FIG. 12 may be simplified by removing is_short_ref field and reference_length variable since this value would now be fixed. Accordingly, the length of references in ‘subs’ box would also be fixed. In the example of FIG. 13, is_short_ref could therefore be removed.

Alternatively, different versions of said box may be defined, each version corresponding to a different maximum number of entries (e.g. 27 for version 0, and 215 for version 1). In this case, even though the length of references may be known directly from the reference table to which a ‘subs’ box refers to, it may be decided to explicitly indicate the length of references in ‘subs’ box so that it remains self-readable.

FIG. 13 illustrates an example of syntax of the ‘subs’ box in embodiments of the invention. This syntax introduces a new version (numbered 2) of the syntax. While versions 0 and 1 explicitly describe all the properties of each sub-sample, version 2 enables describing some of the properties for some sub-samples through a reference to a sub-sample description stored in a SubSampleReferenceTableBox. This syntax is mainly described from a reader point of view, but it respectively applies to a writer during encapsulation.

A first difference, referred as 1300, introduced by this syntax is that if version equals 2, a 1-bit integer is size 16 bits is read (respectively written during encapsulation) to determine (respectively indicate) whether the size of subsamples is described on 16 or 32 bits. is size 16 bits indicates, in version 2 of this box, whether subsample_size is encoded on 16 or 32 bits. When equal to 1, subsample_size is coded on 16 bits. When equal to 0, subsample_size is coded on 32 bits. Then, another 1-bit integer is_short_ref is read (respectively written during encapsulation) to determine (respectively indicate) whether reference indexes are stored on 7 or 15 bits. is_short_ref equals 1 indicates that there are at most 128 entries comprised in SubSampleReferenceTableBox, in which case 7 bits are used to encode the index of an entry in said table. When is_short_ref equals 0, at most 32.768 entries are comprised in the reference table, in which case 15 bits are used to encode the index of an entry in said table.

A second difference, referred as 1310, then occurs in the description of sub-samples when version equals 2. In this case, depending on whether sub-sample size is stored on 16 or 32 bits, the appropriate number of bits is read (respectively written during encapsulation) to determine sub-sample size. Then, 1-bit integer has_reference is read (respectively written during encapsulation) to check (respectively indicate) whether other sub-sample properties are described through a reference or not. has_reference equal to 1 indicates that the values of these properties are identical to the properties in the reference_idx-th entry of SubSampleReferenceTableBox. When equal to 0, it indicates that subsample_priority, discardable and codec_specific_parameters are explicitly indicated for the sub-sample. In this case, the number of bits reference_length that is used to indicate a reference is determined based on the value of is_short_ref. If a reference is used, a reference_idx value is provided. reference_idx is an integer that specifies the index of an entry in the associated SubSampleReferenceTableBox. reference_idx is a 0-based index whose value shall be lower than the number of entries in SubSampleReferenceTableBox. In this case, the values of subsample_priority, discardable and codec_specific_parameters for considered sub-sample can then be obtained from the entry at the indicated index in the associated reference table.

On the other hand, if no reference is used, no reference is read (respectively written during encapsulation). The next 7 bits are reserved, and followed by the indication of subsample_priority, discardable and codec_specific_parameters, as it is the case for versions 0 and 1 of ‘subs’ box.

As an alternative, reference_length may be known directly from the associated reference table, e.g. based on the value of reference_length field in the example of FIG. 12 or by obtaining the value of is_short_ref. The advantage of doing so is that it avoids a potential inconsistency between the value in the ‘subs’ box and the value in the ‘ssrt’ box. However, the drawback is that the ‘subs’ box is no more self-readable, which is generally seen as an issue in ISOBMFF context.

Another remark regarding reference_length is that, even if the considered reference table uses 15 bits for reference indexes, a ‘subs’ may use only 7 bits. In this case, only the 128 first entries of the table can be referenced, but this may be sufficient depending on cases. The 7-bit value can be converted to a 15-bit value by adding padding, for example zero values.

FIG. 14 illustrates an example of syntax for describing the properties of a sub-sample in embodiments of the invention. This syntax may be used as a replacement to legacy representation used in FIG. 12 (block 1210) and FIG. 13 (block 1320). This syntax is mainly described from a reader point of view, but it respectively applies to a writer during encapsulation.

First, instead of using an 8-bit integer to encode the Boolean value discardable, a single bit is used. discardable equal to 0 means that the sub-sample is required to decode the current sample, while equal to 1 means the sub-sample is not required to decode the current sample but may be used for enhancements, e.g., the sub-sample consists of supplemental enhancement information (SEI) messages. Next bit has subsample_priority indicates whether a sub-sample priority is indicated or not. E.g., has subsample_priority equal to 1 indicates that subsample_priority value is present and the value equal to 0 indicates that no subsample_priority value is present. subsample_priority is an integer specifying the degradation priority for each sub-sample. Higher values of subsample_priority, indicate sub-samples which are important to, and have a greater impact on, the decoded quality. When not present, its value is inferred to 0. The setting of subsample_priority is described hereafter.

Next bit is_csp_present indicates whether codec_specific_parameters is present or not. E.g., is_csp_present equal to 1 indicates that codec_specific_parameters is present and the value 0 indicates no codec_specific_parameters value is present. codec_specific_parameters is defined by the codec in use. If no such definition is available, this field shall be set to 0. When not present, its value is inferred to 0.

Next 2 bits indicate the value of csp_length_minus_1, which corresponds to the number of bytes used to describe codec_specific_parameters minus 1. csp_length_minus_1 indicates the number of bytes, minus 1, used to encode the codec_specific_parameters value. The setting of codec_specific_parameters is described hereafter.

Next 3 bits are reserved.

If has subsample_priority equals 1, integer an 8-bit subsample_priority is read. Else, subsample_priority is set to 0.

Finally, if is_csp_present equals 0, codec_specific_parameters value is set or inferred to 0. Otherwise, codec_specific_parameters value is read (respectively written during encapsulation) on the next 8*(csp_length_minus_1+1) bits. Since codec_specific_parameters is expected to be a 32-bit value, obtained bits, if fewer than 32, may be left-shifted to obtain a 32-bit value.

Thanks to this new representation, if there is no need to indicate a subsample_priority distinct from 0, only 1 byte is used to describe discardable and subsample_priority, which means that 1 byte is saved compared to usual representation. In addition, other bytes may be saved depending on the value of codec_specific_parameters. For instance, value 0 does not require a single additional byte, and values in the range 1 to 256 can be indicated using 1 byte.

In embodiments, it may be decided that csp_length_minus_1 is not determined by the actual value of codec_specific_parameters, but by the type of codec_specific_parameters. This may typically occur if reference tables are typed based on flags value, like ‘subs’ box. In this case, all codec_specific_parameters have the same syntax. In some cases, it may be known based on this syntax that only a limited number of bits are needed because some bits are reserved. Therefore, it may be defined that all values are represented on the lowest number of bits that is a multiple of 8 and greater than or equal to said limited number of bits, e.g. 8 bits if only 5 bits are required. In this situation, csp_length_minus_1 could be indicated just once at the beginning of the box describing the reference table, or even omitted if the flags of the box (or another field of the box) allows determining the type of codec_specific_parameters. This does not make the box more compact, due to byte-alignment, the 2 bits used for each csp_length_minus_1 are not saved but just replaced by reserved bits, but it makes it a bit simpler as writer/reader do not need to write/read these bits for each sub-sample.

In FIG. 14, subsample_priority is set to 0 by default. However, depending on implementations and use cases, it may happen that another value is the most frequent one (e.g. 255 or 128). Therefore, it could be advantageous to enable defining a default value for subsample_priority in each box that uses the proposed new representation of sub-sample priorities. This definition would typically be made at the beginning of the box, for instance in the block 1300 of FIG. 13 or at the beginning of FIG. 12. Alternatively, it could be defined in any box that contains such boxes, for instance in a ‘moov’ or a ‘trak’ box. The advantage of doing so is that a single definition would be made, instead of one per box. As another alternative, it may be specified that the flags of boxes that use this new representation indicate whether a default value is used, and possibly what this value may be (e.g. the most significant bit of flags may indicate whether a default value is specified, and next 2 bits indicate whether this value is 0, 64, 128 or 255 depending on these 2 bits value). Finally, another alternative may involve removing subsample_priority property, which may also be indicated through a bit from flags.

FIG. 15 illustrates an example of an alternative syntax for representing the properties of a subsample in embodiments of the invention. This embodiment is based on the legacy syntax. The person skilled in the art may easily combine this embodiment with the embodiment illustrated by FIG. 14. This embodiment aims at allowing associating an arbitrary number of codec_specific_parameters values to a given sub-sample in block 1500.

This may be especially useful when different ‘subs’ boxes are used with different flags value, but that all these boxes describe the same sub-samples structure (i.e. the same way of splitting a sample into different byte ranges). In this case, the same structure is described several times in order to specify different types of codec_specific_parameters values for each considered sub-sample, i.e. each considered byte range.

The innovative feature of the syntax illustrated by FIG. 15 is that instead of considering a single codec_specific_parameters value, an arbitrary number may be indicated. To do so, a new field csp_count is added that indicates the number of such values. As a remark, if this proposal is used in conjunction with the new representation of FIG. 14, the three reserved bits of FIG. 14 could be used to encode csp_count. Indeed, in most cases, csp_count is very unlikely to be greater than 8 as most specifications define fewer than 8 different types of codec_specific_parameters.

For each of these codec_specific_parameters value, its type is indicated through the field csp_type on 24 bits. The reason for using 24 bits is that said type is defined in specifications as the value of ‘subs’ box flags, which is a 24-bit value. Then, a 32-bit codec_specific_parameters value is indicated. Optionally, since flags values are generally low, typically lower than 128, it may be decided to define a more efficient encoding for the type, for instance by first considering a is_compact flag (1 bit), which is followed by a type value on 7 bits when type value is lower than 128. If the type value is greater than 128, the next 7 bits may instead be reserved, and the type value is indicated in the next 24 bits.

As previously described, the type of data indicated in codec_specific_parameters is generally determined by the flags value of the ‘subs’ box in which it is contained. However, with FIG. 15 proposal, this is not necessarily the case. If we consider that this new representation is used in conjunction with e.g. version 2 of ‘subs’ box (independently from whether version supports references or not), then it may be described that when version 2 of the box is considered, flags value should be set to 0 and is no more representative of the type of codec_specific_parameters value. Even if its value is different, said value may be ignored.

In the following, some further embodiments are described where it is proposed to define the notion of property, each property being characterized by an ID (implicit, explicit or predefined) and an encoding format for its associated value (explicit or predefined). Then, each subsample can be mapped to an arbitrary number of properties. In addition, optionally, so that reader can easily determine whether to parse such a box or not, all the types of properties used in a given box are indicated at the beginning of said box.

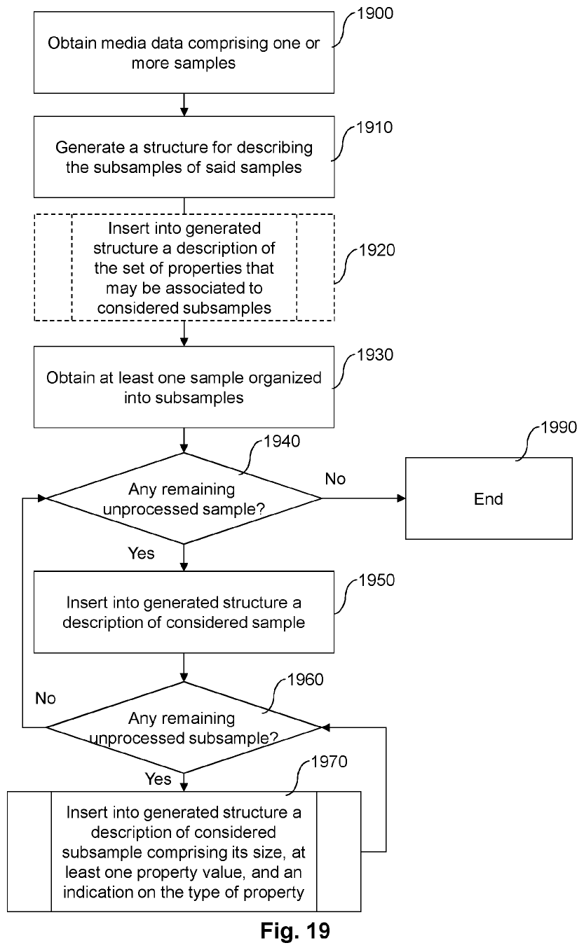

FIG. 19 illustrates the main steps of an example of a method for encapsulating media data according to the invention.

The process starts at step 1900 by obtaining media data comprising one or more samples. Then, at step 1910, a data structure, typically a box, for describing the subsamples of said samples is generated. As a remark, please note that we do not describe here the encapsulation process at a higher level (e.g. ‘moov’, ‘trak’, ‘stbl’ or ‘mdat’ boxes) as this is considered to be well known by one skilled in the art. Said data structure generally has the same role has the ‘subs’ box, hence it is typically located inside the sample description, for example an ‘stbl’, a ‘traf’ or an ‘ipco’ box. Generated data structure may either be a new type of box box (e.g. with a new 4CC), or a ‘subs’ box with a new version number, hence associated to a new syntax compared to existing ‘subs’ box. The data structure generated at step 1910 is sometimes called subsample description box in the following.

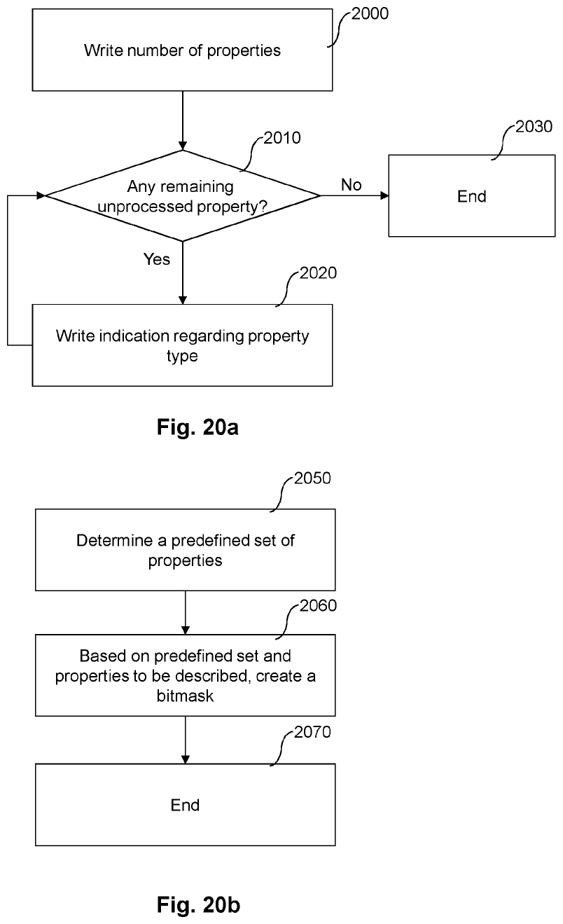

Optionally, at step 1920, a description of the set of the properties which are each associated to at least one of the considered subsamples is inserted into generated structure. A property is defined by an identifier, which may be implicit or explicit, and an encoding format used to encode values corresponding to said property. This identifier actually identifies the type of the property. For instance, a Boolean such as the discardable attribute may be defined as a property whose values are encoded on a single bit, 0 meaning false and 1 meaning true. Alternatively, another property whose values are Boolean values may be encoded on 8 bits, the first bit corresponding to the Boolean value, and the next 7 bits being used just to keep byte alignment. As another example, a property indicating a tile identifier may be defined as a 32-bit integer, with a first bit indicating whether a tile id is indicated, and next 31 bits indicating the value of considered tile identifier. More details about this optional step are provided with regards to FIGS. 20a and 20b.

At step 1930, at least one sample organized into subsamples is obtained. The number of samples can then be inserted into the generated subsample description box of step 1910 (in FIG. 2, this number corresponds to the variable “entry_count”). At step 1940, it is checked whether there remains an unprocessed sample. If so, step 1940 is followed by step 1950 where a description of considered sample is inserted in generated structure of step 1910. Such a description is typically similar to known sample description in existing ‘subs’ box or complies with the different embodiments described below. As illustrated by FIG. 2, sample may be characterized using sample_delta and subsample_count. Sample_delta is used to allow skipping some samples for which no subsample description is provided, typically because these samples are not divided into subsamples.

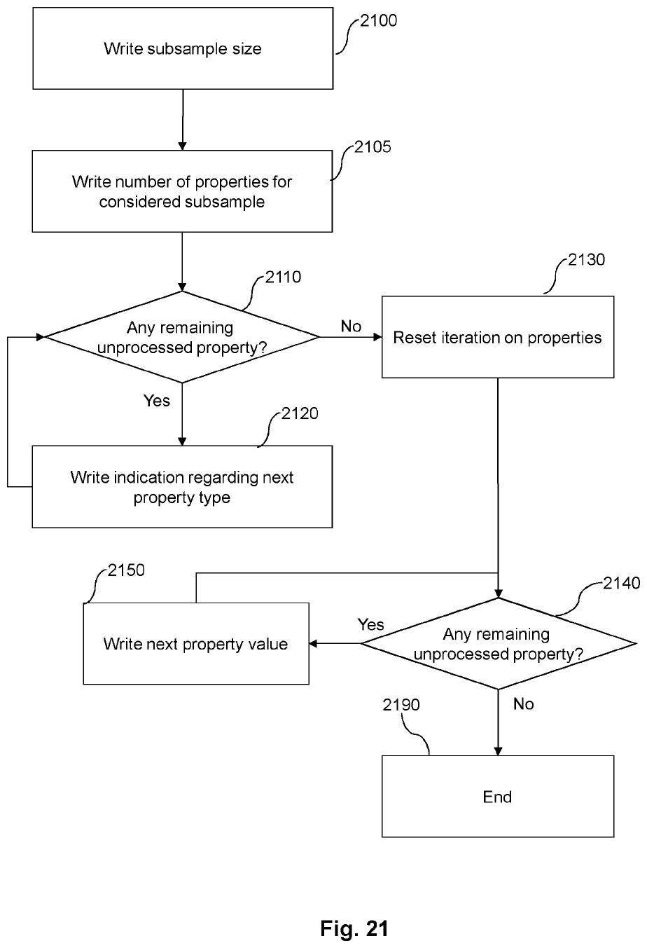

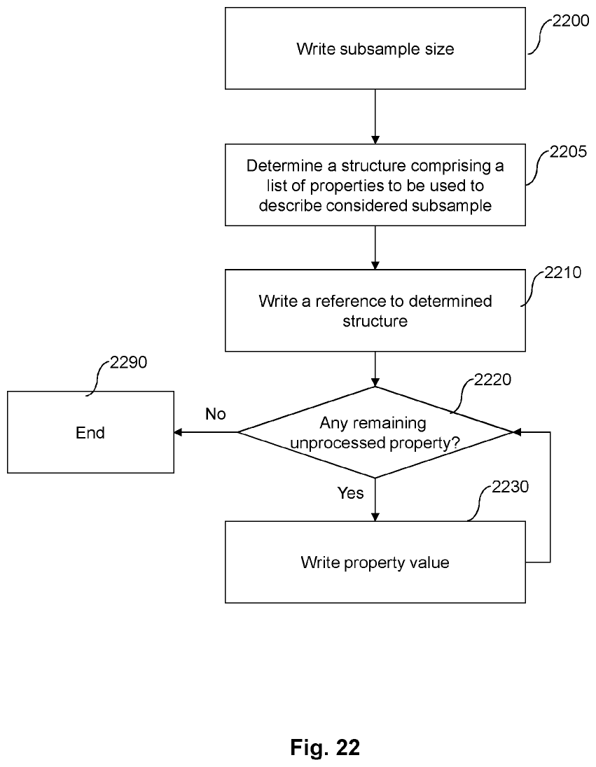

Following step 1950, it is checked at step 1960 whether there remains any unprocessed subsample. If so, a description of considered subsample is inserted into generated structure at step 1970. This description typically comprises subsample_size and, for each property, an indication on the property type as well as corresponding property value. The indication may be explicit or implicit. More details about this step are provided with regards to FIG. 21 and FIG. 22, that each provides a different embodiment of the subsample description method.

Step 1970 is followed by step 1960. When all subsamples have been processed, step 1960 is followed by step 1940. When all samples have been processed, step 1940 is followed by step 1990, where the process ends.

Eventually, the media data comprising the corresponding subsamples are encapsulated in the media file along with the subsample description box.

FIGS. 20a and 20b provide two different embodiments for the optional description, we may call it the used properties description structure in the following, that may be inserted in the data structure in optional step 1920. This optional description describes the set of the properties which are each associated with at least one of the considered subsample in the subsample description box generated at step 1910.

A property is defined by an identifier, which may be implicit or explicit, and an encoding format used to encode values corresponding to said property. If such a value is indicated for a given subsample, we say that this property is specified for said subsample. Encoding formats used to encode values are advantageously byte-aligned, so that byte alignment can be preserved when encoding said values. An example of an implicit identifier is the index of a given property in a list of properties. The list of properties may be included in the media file, for example as a Box, or may be pre-defined as code values or code points in a standard specification. An explicit identifier is, for instance, a unique integer or string assigned to a given property. In a particular embodiment, a property identifier may be a 4CC, in which case different file format specifications may refer to the same properties (e.g. “tile” property could be defined as “tipr” for “tile property”, and any codec using tiles, such as HEVC, VVC or G-PCC, could refer to this property in its corresponding file format specification).

A property that is not present in the considered set of properties cannot be specified for any subsample of considered structure. On the other hand, a property present is necessarily used for the description of at least one of the subsamples described in the data structure generated at step 1910, but not necessarily specified for each subsample.

The used properties description structure comprising the description of the set of properties is optionally inserted in the subsample description box generated at step 1910, where it may allow a reader to determine whether it should parse said structure or not. Indeed, depending on use cases, a reader may need a given type of information to provide a given feature, but it may not be interested in another type of information. For instance, if an application makes no use of tile information, corresponding reader has no need to parse a structure that describes only tile information (i.e. the only property in the list of properties is a tile-related property). Parsing only useful structures allows saving time and resources. Therefore, it is advantageous that this description is inserted at the beginning of the subsample description box, so that reader can quickly determine whether it should continue the parsing or not. If there is no need to continue the parsing, reader can directly move to the next box. This is possible since with ISOBMFF, the size of each box is indicated to reader. When the optional description of the used properties is not inserted in the subsample description box, the parser needs to parse the entire box to find out if it contains relevant information to be used in the parsing depending on the target application for example.

In a given embodiment, this description is inserted at the beginning of the structure of step 1910, but only after all the subsamples descriptions have been inserted in said structure, or at least generated and stored prior to their insertion in said structure (i.e. after step 1940 and before step 1990). Indeed, by doing so, the list of properties that are present in said structure can be built by adding each property not yet added to said list while iterating through subsamples.

FIG. 20a illustrates the main steps of a method for generating the used properties description structure according to a first embodiment. This method starts at step 2000 by writing the number of properties in the used properties description structure. These properties are the ones that may be specified for a given subsample of considered obtained data (each of these properties may or may not be specified for each subsample). Then, at step 2010, it is checked whether there remains an unprocessed property. If so, step 2010 is followed by step 2020 where an indication regarding the type of the property is written. As previously mentioned, the indication may for instance be an index in a list, for instance if properties are defined by a specification through a list, or an identifier, for instance if specification defines a unique identifier for each property. This identifier may be a 4CC associated with the property.

Step 2020 is followed by step 2010, and when all properties have been processed, the process ends at step 2030.

FIG. 20b illustrates the main steps of a method for generating the used properties description structure according to a first embodiment. The method starts at step 2050 by determining a predefined set of properties. This predefined set may for instance be the list of all properties defined in the context of a given specification. We consider the predefined set to be ordered, e.g. by growing order of corresponding identifiers. For each property in this set, 1 bit may be used to indicate whether it is specified for one of the subsamples of considered structure or not. By concatenating these bits, it is therefore possible to create a bitmask indicating which properties actually occur in the subsample description box generated at step 1910 once the process of FIG. 19 has been completed (step 2060). In this embodiment, this bitmask corresponds to the used properties description structure. This bitmask can then be inserted into said structure (at same step 2060), which allows determining the set of properties that may be specified for each subsample in considered structure. Following step 2060, the process ends at step 2070.

If there is a need to work with aligned bytes, the bitmask may be complemented with additional bits so that the number of bits in the bitmask is a multiple of 8. For instance, if 5 different properties may be specified for each subsample, three zeros may be appended to the corresponding bitmask to reach 1 byte (for example the most significant bits, since the predefined list may use identifiers in growing order).

Optionally, in some embodiments, default values may be provided for each property present in the used properties description structure. This may be all the more useful as a given value is frequent for a given property.

In such a case, when a property is associated with a default value, the default values applies unless another value is specified for a given subsample. The default value defined at the used properties description structure level may be overwritten in the subsample description box for a given property.

As a remark, and contrary to the case where no default values are provided, it should be noted that a property for which a default value has been indicated cannot be omitted for a given subsample. This means that, for a given subsample for which the property is not explicitly specified in the subsample description box, the value of the property for said subsample is the default value. In other words, the property provided with a default value applies to all the subsamples with the provided default value if not specified at the subsample level, and with the provided value overwriting the default value if specified. Indeed, the value for a considered subsample is either the default one, either another one which has been explicitly indicated. Even though the encoding format associated to each property may define a specific value corresponding to “undefined”, the result is still somehow different from having the property omitted (even though it may practically be identical, since an omitted property may be equivalent to an undefined value for said property).

The description of the set of properties that may be specified for a given subsample may also comprise a flag indicating whether this description applies to all subsamples by default. If so, this means that all properties are expected to be specified for each subsample, unless indicated differently e.g. at subsample level. For instance, even if such a flag is set to true, some means may be provided at subsample level to indicate that this default does not apply to a given subsample (e.g. through a dedicated Boolean in subsample description, or by defining that 1 bit of subsample_size is used to represent this Boolean value), in which case the list of properties specified for considered subsample would be indicated explicitly (on the other hand, if the default applies, no list of properties would be indicated at subsample level, and only the values for each property would be provided).

FIGS. 20a and 20b describe how to create a description of the set of properties that are used to describe subsamples. In the previously described embodiment, the optional used properties description structure is inserted in the subsample description box. In some embodiments, this description is provided in a different structure, e.g. a specific box dedicated to such kind of description. A reference to said structure may be inserted in the structure of step 1910. In other embodiments, the reference is implicit due to the location of the structure. For example, if a single box containing a used properties description structure is comprised in the same container box as the subsample description box, said used properties description may implicitly be associated with said subsample description box.

As an example, descriptions of set of properties may be embedded in a SampleGroupDescriptionBox. This box enables defining a type of grouping (characterized by a unique grouping_type value), said type being associated with a SampleToGroupBox with the same type. The SampleToGroupBox defines groups of samples that can be mapped to different entries (each entry being designated by its index in the list of entries in the SampleGroupDescriptionBox, indexing starting at 1). For instance, a first entry in the SampleGroupDescriptionBox may define a given set of properties, while another entry may define a different set of properties. Once such entries have been described in a SampleGroupDescriptionBox, each entry can be referred to through the group_description_index of the associated SampleToGroupBox (with same grouping_type). For example, a specific SampleGroupEntry may be defined to store list of indexes, each index corresponding to a property index.

FIG. 21 illustrates the main steps of a method for describing a subsample in the subsample description box according to an embodiment of the invention. This method describes a possible implementation of the process of step 1970 in FIG. 19.

First, at step 2100, the subsample size is written. Subsample size is typically written on 16 or 32 bits; whether 16 or 32 bits should be used is for instance indicated through the version number or the flags value of the subsample description box. After that, at step 2105, the number of properties for considered subsample is written. This number corresponds to the number of property values that will be indicated in subsample description. Then, at step 2110, it is checked whether there remains an unprocessed property. If so, at step 2120, an indication of the next unprocessed property type is written. As previously mentioned, this indication is typically an identifier, which may be implicit or explicit, such as an index in a list (implicit) or a unique identifier associated to considered property (e.g. an integer or a 4CC). In an embodiment, where the optional used properties description structure is provided, the indication relative to the type of the property may be an index of the property in the used properties description structure.

Step 2120 is followed by step 2110, and when there is no more unprocessed property, step 2110 is followed by step 2130 where the iteration on properties is reset (i.e. all properties are considered as unprocessed). Another iteration then starts, and at step 2140, it is checked whether there remains an unprocessed property. If so, the value of the next unprocessed property is written at step 2150. The way to encode this value is directly determined by the property. As previously indicated, a property is indeed characterized by an identifier, and an encoding format for its values. As a remark, the reason for distinguishing two iterations is that it enables the factorization described in the following as a possible embodiment (i.e. when applicable, the type indications may be factorized for several subsamples, typically at sample level, while the values remain indicated at subsample level). However, if this factorization is not considered useful, a single loop on properties may be used, with indication types and values being interleaved (or alternatively, indication types and values may be written to two distinct variables, which may then be concatenated as a single field of the data structure, so that indication types and values are not interleaved).

Step 2150 is followed by step 2140, and when there does not remain any unprocessed property, the process ends at step 2190.

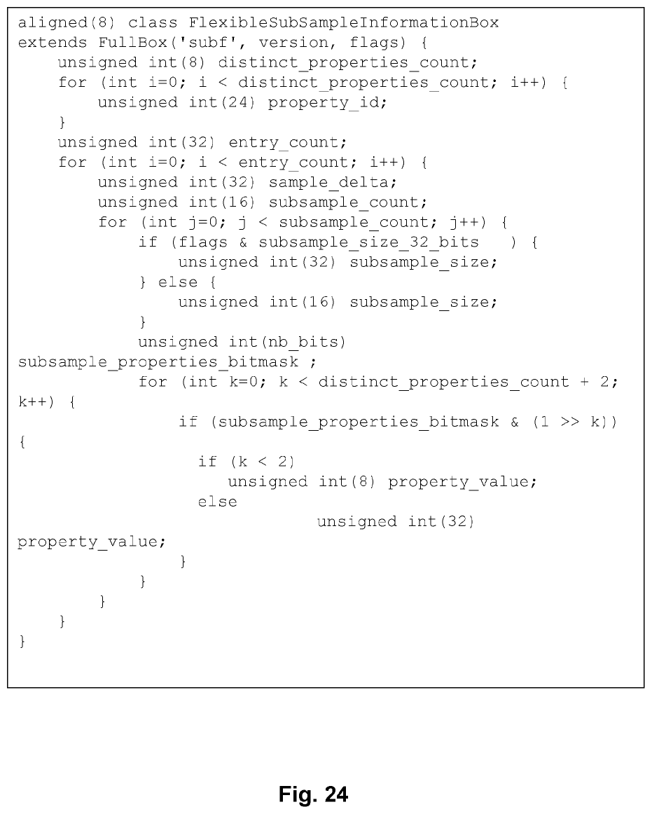

In a specific embodiment where the optional used properties description structure is provided, the number of properties is not indicated at step 2105. Instead, an indication on the presence of a value for each property of the used properties is provided as one bit, the concatenation of these bits forming a bitmask. The size of this bitmask can be directly determined from the number of distinct used properties and is typically equal to the lowest multiple of 8 greater or equal to the number of distinct used properties. In a variant, it may be decided that state-of-the-art subsample_priority and discardable properties should be handled differently from other properties, and that they are therefore not added to the used properties description. Instead, two additional bits can be added to the bitmask, one indicating whether a value is provided for subsample_priority, the other one indicating whether a value is provided for discardable. An example of such an embodiment is provided with regards to FIG. 24.

FIG. 22 illustrates the main steps of a method for describing a subsample in the subsample description box according to another embodiment of the invention. This method describes another possible implementation of the process of step 1970.

First, at step 2200, subsample size is written. After that, at step 2205, a structure comprising a list of properties to be used to describe considered subsample is determined. As previously described, a list of properties may be defined through an entry in a SampleGroupDescriptionBox. This entry can then be referred to through the grouping_type of considered SampleGroupDescriptionBox and entry's index in said box, indexing starting at 1 for example. Alternatively, a new kind of box that simply aims at describing a list of properties may be defined, for example a SubSampleListBox. In this case, such structure could be referred to through a unique identifier assigned to this box. Optionally, some values may also be specified for some of the properties in said structure. In the case of a subsample list box defined in a SampleGroupDescriptionBox, different entries may be distinct simply due to their different values for some properties, meaning that they describe an identical set of properties, but with some differences in the specified property values.

At step 2210, a reference to determined structure is provided in the description of considered subsample in the subsample description box. Based on this reference, it is possible to determine the properties for which a value is going to be specified in the description of the subsample. In particular, if a value has already been specified for a given property in determined structure, the subsample list box, then no value is expected for this property in considered description, and the property is considered as already processed.

Step 2210 is followed by step 2220, where it is checked whether there remains an unprocessed property. If so, its value is written at step 2230 using the encoding format defined for considered property, and the process loops at step 2220. When there does not remain any unprocessed property, the process ends at step 2290.

For each property for which a default value is provided, an indication regarding whether the default value applies to current subsample may be indicated in subsample description in the subsample description box. This indication is typically a single bit, but that may be converted to a byte in order to preserve byte alignment. Alternatively, all such single bits may be concatenated to form a bitmask and said bitmask may be added to the description. By using such a bitmask, fewer bits are wasted due to byte alignment. Finally, another solution may also be to use, for each property, 1 bit from its subsample_size to indicate whether its default value applies or not.

In other words, this embodiment proposes to describe the types of the properties associated with a given subsample in an external data structure (box or data structure inside a box) that is referred to in the subsample description box. The corresponding property values being still described in the subsample description box. Optionally, the external data structure may comprise default values. In that case, no value is expected at the subsample level. In a variant, the default value can be overwritten in the subsample description box at subsample level. In a variant, the subsample description box may comprise a first reference to default property values in an external data structure and a second reference in sub-sample description for a given subsample to the types of properties that override the default property values with properties values for the given subsample.

When the file is segmented in track fragments, there may be an ambiguity with regards to the references made to the subsample list box describing list of properties. In particular, it may happen that such structures may be defined at two different levels, one global, common to all fragments (in a ‘moov’ box), and one specific to each fragment (in a ‘traf’ box, inside a ‘moof’ box). Generally speaking, some data may be defined at these two levels since this allows defining some default values at the file level, that may be used by all fragments, but that can also be overwritten, meaning replaced at fragment level.

Therefore, in such a situation and in the context of the embodiment when references to structures describing the list of properties are made, an indication may be added to each subsample description in order to indicate whether the referenced structure is the one defined at the global level, or at the fragment level. When the structure of step 2200 relies on sample group, this is already supported by using group_description index offseted by 0x10000.

In order to minimize the number of values to be written, it may be decided to define a rule such that, starting from the second subsample, unless a value is specified for a given property and a given subsample, the value of said property for said subsample is the same as the value of said property for previous subsample. In particular, if the property was omitted for previous subsample, the property is also considered as omitted for current subsample.

Since this rule requires to be aware of previous subsamples, it may be defined that the rule applies only within a given scope. For instance, it may be decided to reset the rule for each new fragment or for each subsample description box generated at step 1910.

When using such a rule, once a property has been specified for a given subsample, it cannot be omitted. If a given value has been defined as “undefined” for considered property, it is possible to specify this value of the property for a considered subsample, which should be equivalent to omitting it. Yet, if there is a need to enable an omission, a dedicated indication may be included in the description of subsample. For instance, it may be decided that a bitmask is included in each subsample description, the bits in the bitmask corresponding to Boolean values indicating whether the “same if not specified” rule shall apply or not to considered properties (considered properties would typically be the properties that were specified for previous subsample). If the flag is equal to 0 for a given property, this means that the value should be omitted, unless a new value is explicitly specified for this property in subsample description.

If the same properties are specified for all the subsamples of a given sample, it may be decided to factorize corresponding subsamples description at sample level to minimize the number of bytes used for these descriptions. In order to determine whether a factorized description is provided or not, a Boolean attribute may be defined. When true, such a factorized description is provided and applies to all corresponding subsamples; when false, no such factorized description is provided, and instead, a specific description is indicated for each subsample at the subsample level.

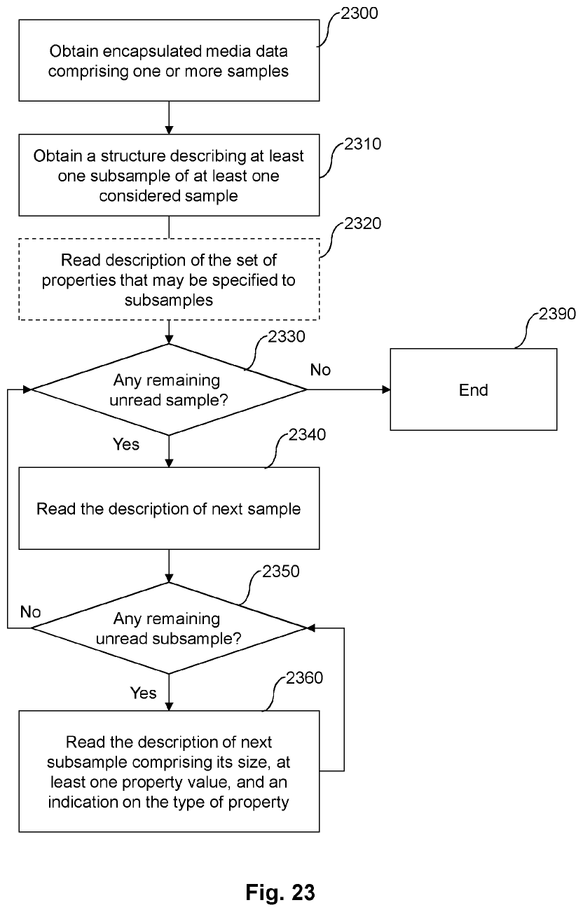

FIG. 23 illustrates the main steps of an example of method for reading encapsulated media data according to one of the encapsulation methods herein described.

First, at step 2300, such encapsulated media data comprising one or more samples is obtained. Then, at step 2310, the data is parsed by a reader until obtaining a structure describing at least one subsample of at least one considered sample. This is typically the subsample description box generated at step 1910.

If the parsed subsample description box comprises the optional used properties description structure, step 2320 is performed to read the description of the set of properties that may be specified for the subsamples described in this subsample description box. By reading said set of properties, the reader can determine whether it would like to parse the whole structure, or if it may skip it.

Step 2320, or step 2310 if step 2320 is not performed, is followed by step 2330 where it is checked whether there remains any unread sample. If so, the description of next sample is read at step 2340. The reading of this description typically involves reading sample_delta and subsample_count values, as described with reference to FIG. 19.

Next, it is checked at step 2350 whether there remains any unread subsample for considered sample. If so, the description of next subsample is read at step 2360. In particular, its size, at least one property value, and, for each property value, an indication on the type of the property are read. As described with regards to the encapsulating side, some property values may be defined through the usage of default values, and specific mechanisms allowing to reduce the verbosity of the description may be used (e.g. the “same if not specified” rule). More generally, all the mechanisms that have been defined for the encapsulating side also apply to the reader side.

Eventually, the subsamples are read according to the parsed properties associated with them.

While the presented methods allows having properties of arbitrary length, in some embodiments, the properties may have a fixed length. In particular, properties may always comprise 32 bits. A benefit of this approach is that it allows defining a single encoding format for a property that may be encoded as a codec_specific_parameters in a state-of-the-art ‘subs’ box and in a new box according to the invention. In this case, each distinct property is associated to a given flags value in the case of the ‘subs’ box (this flags value is used to indicate the format of codec_specific_parameters value). That flags value therefore uniquely identifies a given property: hence, it can be used as an identifier of said property when using a subsample description box according to the invention. By doing so, the current ‘subs’ may easily coexist with an alternative box according to the presented methods. Adopting the box according to the presented methods may therefore be seamless for file format specifications. On the other hand, if properties of variable length are considered, state-of-the-art ‘subs’ box is not adapted, and specifications would have to deal with this issue (e.g. by dropping existing ‘subs’ box, or by defining somehow twice the same properties, once on 32 bits for existing ‘subs’, and once on an arbitrary number of bytes for the box according to the invention).

FIG. 24 illustrates an example of syntax for a subsample description box according to this embodiment. As an example, this box is named FlexibleSubSampleInformationBox and may be referred to as ‘subf’ or can be named ExtendedSubSampleInformationBox and may be referred to as ‘esub’. First, the used properties description structure of step 1920 is indicated, with the process described in FIG. 20a. The distinct count of properties is first indicated, then identifiers for each property are listed (i.e. each property_id corresponds to an existing flags value for the ‘subs’ box).

After that, the organisation of samples and subsamples is described using means similar to existing ‘subs’ box. The description of each subsample is made according to FIG. 21 process (and without step 2105, which is not required when using a bitmask to provide indication of types of properties). A slight difference with state-of-the-art comes from the fact that the number of bits used to encode the sample size is not determined based on the version value of the box, but based on a dedicated subsample_size_32_bits flag. This flag value is for instance the value of the first bit of box's flags value.

Then, each subsample is further described by first indicating a bitmask (variable subsample_properties_bitmask) indicating which values are provided for current subsample. This bitmask comprises nb_bits, nb_bits being the lowest multiple of 8 that is greater or equal to distinct_properties_count+2. Values that may be provided for current subsample include a subsample_priority value and discardable value, both with the same format as in SubSampleInformationBox, as well as values corresponding to the distinct properties listed at the beginning of current box. A bit equal to 1 indicates that a value is explicitly provided, while a bit equal to 0 indicates that no value is explicitly provided. The first bit indicates whether subsample_priority is indicated, the second bit indicates whether discardable is indicated, and next nb_bits—2 bits indicate whether a value is provided for each of the properties listed in the list of distinct properties present in current box, corresponding to the optional used properties description structure described above. If no value is explicitly specified for a given property, the value of said property for current sub-sample is the last explicitly specified value for said property. For the first described sub-sample, a property must be explicitly specified for each distinct property.

Finally, following the subsample_properties_bitmask, the corresponding values are provided (property_value field). The two first values that may be provided are subsample_priority and discardable, which are encoded on 8 bits. Then, next values (if any) are encoded on 32 bits.

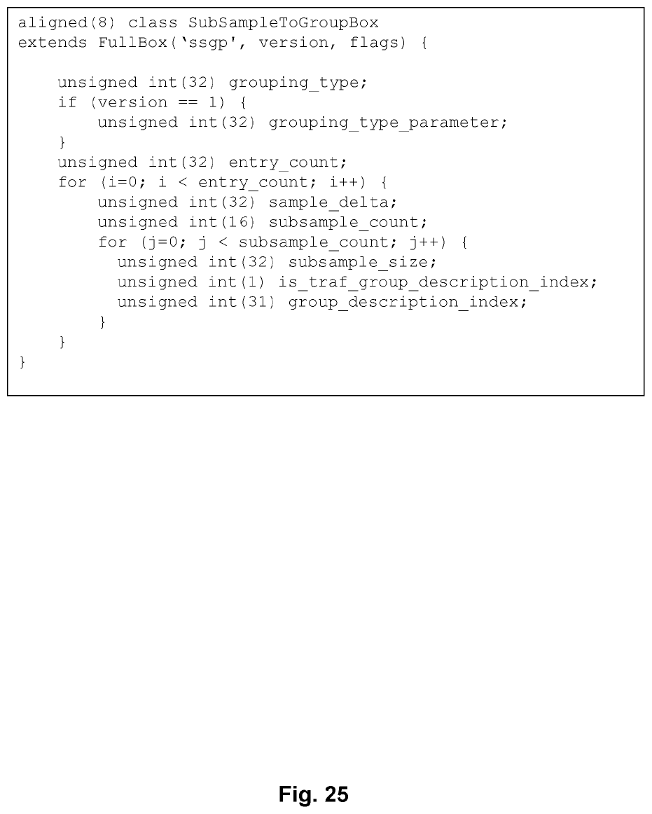

FIG. 25 provides an example of a SubSampleToGroupBox that may be used as a subsample description box in conjunction with sample groups defined in a SampleGroupDescriptionBox, as previously described, for instance in the description of FIG. 22. This box comprises a grouping_type value that indicates the SampleGroupDescriptionBox it refers to, as well as a grouping_type_parameter that may be defined if the box's version value is equal to 1. The grouping_type is used to associate the SubSampleToGroupBox (‘ssgp’) to its corresponding SampleGroupDescriptionBox (‘sgpd’). A SubSampleToGroupBox can be defined in the SampleTableBox ‘stbl’ or at movie fragment level, for example in a ‘traf’ box. The indication of samples having a sub-sample description is described through parameters from the sub-sample information box, namely entry_count and sample_delta values. The number of subsamples for a sample is then indicated through the value subsample_count, and for each subsample, its size is indicated (here on 32 bits, but size may be variable depending e.g. on box's version value or flags value), as well as the group_description_index corresponding to the entry from corresponding SampleGroupDescriptionBox that is used as a reference for considered subsample. Said entry describes the actual properties specified for considered subsample, including its values. Alternatively, and as previously described, only some of the values may be indicated in said entry, in which case missing values would be added to the subsample description. An entry in the SampleGroupDescriptionBox with a grouping_type indicating sub-sample information can be defined as a specific SampleGroupDescriptionEntry (since applies to any kind of track). It may consist in a parameter on a fixed number of bits, as follows:

```
  class SubSampleGroupEntry( ) extends SampleGroupDescriptionEntry
(‘ssgp’) {
    unsigned int(32) subsample_property;
  }
```

This representation allows backward compatibility with existing sub-samples properties, defined for example in ISO/IEC 14496-15. Moreover the default_length of the SampleGroupDescriptionBox can then be used, since all entries have the same size.

Alternatively, the content of the sub-sample group entry may be provided as an encoding size (preferably byte-aligned) and a value for the subsample_property (for example the property_value parameter):

```
  class SubSampleGroupEntry( ) extends SampleGroupDescriptionEntry
(‘ssgp’) {
    unsigned int(8) encoding_size_in_bytes;
    unsigned int(encoding_size_in_bytes) property_value;
  }
```

This representation allows efficient representation of a sub-sample property, fitting the number of bytes to the possible range of values for a sub-sample property. The parameter property_value provides the value for the sub-sample property.

Alternatively, the content of the sub-sample group entry may be provided as a list of parameters, encoded on fixed or variable size (only variable size illustrated below):

```
  class SubSampleGroupEntry( ) extends SampleGroupDescriptionEntry
(‘ssgp’) {
    unsigned int(8) property_count;
    for (int i=0; i < property_count; i++) {
      unsigned int(8) encoding_size_in_bytes;
      unsigned int(encoding_size_in_bytes) property_value;
    }
  }
```

This representation allows to associate sub-sample(s) to one or more sub-sample properties, through the group_description_index parameter of the SubSampleToGroupBox.

Yet as another alternative, the content of the sub-sample group entry may consist in a type-length-value, or in a list of type-length-values (as illustrated below), the length being given by the default_length or by the description_length parameter of the SampleGroupDescriptionBox:

```
  class SubSampleGroupEntry( ) extends SampleGroupDescriptionEntry
(‘ssgp’) {
    unsigned int(8) property_count;
    for (int i=0; i < property_count; i++) {
      unsigned int(8) encoding_size_in_bytes
      unsigned int(8) property_type;
      // property_length is given by SampleGroupDescriptionBox;
      unsigned int(encoding_size_in_bytes) property_value;
    }
  }
```

Where property_type indicates the type of the property (e.g. an index in a pre-defined list, a reserved code, a 4CC, a URN, or any means to uniquely identify a property type). It is to be noted that, depending on the means used for indication of the property_type, 8 bits may not be sufficient and 32 bits may be used instead (for example when using a 4CC). The property_value contains the actual value for the property of the indicated type. It can be encoded on a number of bytes fit to the property_length.

Another variant may describe the encoding_size_in_bytes outside the loop on properties, considering that all values will be encoded with the same number of bytes. This is easier to set the value of the description_length parameter in the SampleGroupDescriptionBox. The SubSampleToGroupBox and its associated SampleGroupDescriptionBox inherit the properties of sample groups like the default sample grouping (unmapped sub-samples are associated to the default group description index when the version 2 of the SampleGroupDescriptionBox is used) or like the static mapping of sub-samples or like the static group description index and their combinations.

Finally, subsample description from FIG. 25 also comprises a Boolean value is_traf_group_description_index; this value is useful when fragments are used, as it indicates whether the SampleGroupDescriptionBox referred to through grouping_type is the global one (‘moov’ box), or the fragment-specific one (‘traf’ box).

Any step of the algorithms described herein may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating media data in a media file, the media data comprising one or more samples, at least one of the one or more samples being organized into subsamples, the method comprising:
generating subsample descriptive metadata describing the subsample information, the subsample descriptive metadata comprising for each subsample a subsample description;
wherein each subsample description comprises an indication indicating whether the subsample description comprises a reference to at least one subsample's property or a subsample's property.

2. The method of claim 1, wherein the method further comprises:
generating a reference table descriptive metadata describing a table of subsample's properties; and
wherein the reference is a reference to at least one subsample's property in the reference table descriptive metadata.

3. The method of claim 1, wherein the reference is a reference to at least one subsample's property of another subsample described by the subsample descriptive metadata.

4. The method of claim 2, wherein:
the reference table descriptive metadata is a box further describing a group of entities;
subsample descriptive metadata is generated for each entity, the generated subsample descriptive metadata comprising a reference to the table of subsample's properties described in the box.

5. The method of claim 2, wherein:
a plurality of reference table descriptive metadata are generated;
the reference is a reference in one of the reference table descriptive metadata;
the reference table descriptive metadata referred to by the reference is identified by its location in the metadata.

6. The method of claim 2, wherein:
a plurality of reference table descriptive metadata are generated;
the reference is a reference in one of the reference table descriptive metadata;
the reference table descriptive metadata referred to by the reference is identified by a flags value of the reference table descriptive metadata.

7. The method of claim 6, wherein the reference table descriptive metadata referred to by the reference is identified by a flags value of the reference table descriptive metadata equal to the flags value of the subsample descriptive metadata.

8. The method of claim 2, wherein:
a plurality of reference table descriptive metadata are generated;
the reference is a reference in one of the reference table descriptive metadata;
the reference table descriptive metadata referred to by the reference is identified by a table identifier comprised in each reference table descriptive metadata.

9. The method of claim 2, wherein:
a plurality of reference table descriptive metadata are generated;
the reference is a reference in one of the reference table descriptive metadata;
the reference table descriptive metadata referred to by the reference is identified by a flag in each reference to the table descriptive metadata.

10. The method of claim 1, wherein the subsample descriptive metadata further comprises an indication of the number of bits used for representing the reference.

11. The method of claim 1, wherein the subsample description comprises an arbitrary number of codec_specific_parameters values.

12. A method of reading media data in a media file, the media data comprising one or more samples, at least one of the one or more samples being organized into subsamples, the method comprising:
obtaining from the media file subsample descriptive metadata describing the subsample information, the subsample descriptive metadata comprising for each subsample a subsample description;
wherein each subsample description comprises an indication indicating whether the subsample description comprises a reference to at least one subsample's property or a subsample's property; and
obtaining the property describing the subsample from the subsample's property of the subsample description or from the referenced at least one subsample's property based on the indication.

13. (canceled)

14. A non-transitory computer-readable storage medium storing instructions that when executed by a computer executes a method comprising:
generating subsample descriptive metadata describing the subsample information, the subsample descriptive metadata comprising for each subsample a subsample description;
wherein each subsample description comprises an indication indicating whether the subsample description comprises a reference to at least one subsample's property or a subsample's property.

15. (canceled)

16. A device for encapsulating media data in a media file, the media data comprising one or more samples, at least one of the one or more samples being organized into subsamples, the device comprising a processor configured for:
generating subsample descriptive metadata describing the subsample information, the subsample descriptive metadata comprising for each subsample a subsample description;
wherein each subsample description comprises an indication indicating whether the subsample description comprises a reference to at least one subsample's property or a subsample's property.

17. A device for reading media data in a media file, the media data comprising one or more samples, at least one of the one or more samples being organized into subsamples, the device comprising a processor configured for:
obtaining from the media file subsample descriptive metadata describing the subsample information, the subsample descriptive metadata comprising for each subsample a subsample description;
wherein each subsample description comprises an indication indicating whether the subsample description comprises a reference to at least one subsample's property or a subsample's property; and
obtaining the property describing the subsample from the subsample's property of the subsample description or from the referenced at least one subsample's property based on the indication.
